(19) United States
(12) Patent Application Publication
(10) Pub. No.: US 2013/0169071 A1
(43) Pub. Date: Jul. 4, 2013

(54) OSCILLATING ACTUATOR

(71) Applicants: Masaya Endo, Warabi-shi (JP); Shin Odajima, Nakano-ku (JP); Yoshihide Tonogai, Saitama-shi (JP)

(72) Inventors: Masaya Endo, Warabi-shi (JP); Shin Odajima, Nakano-ku (JP); Yoshihide Tonogai, Saitama-shi (JP)

(73) Assignee: NIDEC COPAL CORPORATION, Itabashi-ku, Tokyo (JP)

(21) Appl. No.: 13/807,270

(22) PCT Filed: Jun. 27, 2011
(86) PCT No.: PCT/JP2011/064697

§ 371 Date: Mar. 13, 2013

(30) Foreign Application Priority Data
Jun. 30, 2010 (JP) 2010-149419
Mar. 31, 2011 (JP) 2011-080506

(51) Int. Cl. H02K 33/12

(52) U.S. Cl. CPC H02K 33/12
USPC 310/25

(57) ABSTRACT

An oscillating actuator comprising a shaft, arranged along an axis of oscillation of a housing, having both ends fixed to end walls provided at both ends of the housing; a movable element having a magnet adapted to pass the shaft therethrough and movable in an extending direction of the shaft and a weight arranged adjacent to the magnet in the extending direction of the shaft, adapted to pass the shaft therethrough, and movable integrally with the magnet; and an elastic member, arranged between the movable element and the end wall, for urging the movable element in the oscillation axis direction; wherein the coil comprises first and second coils wound annularly about the axis of oscillation and disposed in parallel with each other in the oscillation axis direction, the first and second coils having respective current flowing directions different from each other.

### TECHNICAL FIELD

One aspect of the present invention relates to a small-sized oscillating actuator which is utilized in vibration generation sources for informing users of incoming calls to mobile wireless devices such as mobile phones, those for transferring feels of operating touch panels and realistic sensations of game machines to fingers and hands, and the like.

### BACKGROUND ART

Japanese Utility Model Application Laid-Open No. 5-60158 has conventionally been known as a technique in such a field. The oscillating actuator disclosed in this publication is one in which a movable element is constructed by a magnet and a weight which are contained in a tubular body and linearly oscillates in the axial direction of the tubular body. In this oscillating actuator, the outer periphery of the tubular body is provided with a recess on which a coil is disposed. The magnet is arranged in an inner diameter part of the recess along the axial direction thereof. The magnet extends from the inner diameter part of the recess into the barrel of the tubular body. The weight is joined to one end of the extended magnet. Both ends of the movable element constructed by the magnet and weight are supported by end plates of the tubular body through springs.

Also known as a technique in such a field is an oscillating actuator in which, as described in the following Patent Literature 2, a shaft is fixed within a cylindrical housing, while a movable element oscillates along the shaft. The movable element of this oscillating actuator comprises a cup-shaped yoke disposed on the shaft, a weight bonded to the outer peripheral bottom face of the yoke, and a magnet arranged within the yoke. The yoke, weight, and magnet are provided coaxially with the shaft. The movable element is held by coil springs on both sides in the axial direction thereof. Between the cup-shaped yoke and the magnet, a coil bobbin and a drive coil are arranged so as to surround the magnet.

Thus constructed movable element slides along the shaft when oscillating. A part of the shaft is provided with a stage having a reduced diameter, so as to separate the magnet therefrom and prevent it from coming into contact therewith. This reduces frictions occurring between the movable element and the shaft.

### CITATION LIST

### Patent Literature

Patent Literature 1: Japanese Utility Model Application Laid-Open No. 5-60158
Patent Literature 2: Japanese Patent Application Laid-Open No. 2003-220363

### SUMMARY OF INVENTION

### Technical Problem

Since the oscillating actuator disclosed in Patent Literature 1 has a structure in which the movable element constructed by the magnet and weight is simply supported by the springs, however, the weight can relatively freely swing in directions different from the axial direction within the tubular body. This yields a possibility of the weight shifting its center of gravity position from the axis or colliding with the tubular body upon drop impact. Therefore, it can be considered a structure which is hard to secure stable oscillations and has a low resistance to drop impact. Further, a large inertia force applied to the weight under drop impact may remove the end plates from the tubular body and eject the movable element.

The oscillating actuator described in Patent Literature 2 has no disclosure concerning any method for fixing the magnet to the yoke. Therefore, when the magnet is not fully fixed to the yoke, the magnet may shift its position radially of the shaft, thereby rattling radially of the shaft.

It is an object of one aspect of the present invention to provide an oscillating actuator adapted to improve its resistance to drop impact while securing stable oscillations. It is an object of one aspect of the present invention to provide an oscillating actuator which can secure stable oscillations by preventing the magnet from rattling radially of the shaft.

### Solution to Problem

The oscillating actuator in accordance with one aspect of the present invention is an oscillating actuator having a coil arranged within a tubular housing and a magnet arranged within the housing while being surrounded by the coil, the coil and the magnet cooperating with each other so that the magnet oscillates linearly along an axis of oscillation of the housing, the oscillating actuator comprising a shaft, arranged along the axis of oscillation of the housing, having both ends fixed to end walls provided at both ends of the housing in the oscillation axis direction of the housing; a movable element having the magnet adapted to pass the shaft therethrough and movable in an extending direction of the shaft and a weight arranged within the housing adjacent to the magnet in the extending direction of the shaft, adapted to pass the shaft therethrough, and movable integrally with the magnet; and an elastic member, arranged between the movable element and the end wall, for urging the movable element in the oscillation axis direction; wherein the coil comprises first and second coils wound annularly about the axis of oscillation and disposed in parallel with each other in the oscillation axis direction, the first and second coils having respective current flowing directions different from each other.

In the oscillating actuator in accordance with one aspect of the present invention, a magnet and a weight are arranged movable in the oscillation axis direction of a housing, and a magnet and a coil surrounding the magnet cooperate with each other, so that the movable element having the magnet and weight linearly oscillates along the axis of oscillation of the housing while receiving an urging force from an elastic member. Here, a shaft having both ends fixed to end walls provided at both ends in the oscillation axis direction of the housing penetrates through the magnet and weight. While being guided by thus fixed shaft, the magnet and weight oscillate integrally. This can prevent the weight from shifting its center of gravity position from the axis of oscillation and secure stable oscillations. This can also prevent the weight from colliding with the housing even under drop impact and thus can improve the resistance to drop impact. In the case where the housing is constituted by two or more parts split in a direction dividing the axis of oscillation, the strength of joining the parts constituting the housing improves when both ends of the shaft are fixed to the respective end walls of the housing as in one, aspect of the present invention. This can avoid a state where the housing is split in the oscillation axis direction under drop impact so as to eject the weight and magnet out of the housing. Thus, the shaft also functions as a joint bar. Further, a magnetic path directed from the magnet to the first coil and a magnetic path returning from the second coil to the magnet are formed, so that a thrust can be generated by both magnetic paths. Therefore, a greater thrust can be obtained as compared with a case using a single coil.

The oscillating actuator may be constructed such that the weight comprises first and second weights arranged on both sides in the oscillation axis direction of the magnet, the elastic member comprises a first compression spring arranged between the first weight and one end wall of the housing and a second compression spring arranged between the second weight and the other end wall of the housing, and respective annular pole yokes are arranged between the magnet and the first and second weights.

In this case, the weight, pole yokes, and magnet oscillate while receiving urging forces from the first and second compression springs from both sides, whereby stable oscillations can be obtained securely and easily. By employing the first and second compression springs opposing each other, the weight, pole yokes, and magnet are joined to one another in the oscillation axis direction so as to be integrated, whereby the parts can be joined together without using adhesives. Since the shaft penetrates through the weight, pole yokes, and magnet in particular, a protruded excess of an adhesive, if any, and the shaft may slide on each other, so as to produce frictional resistance. However, one aspect of the present invention can avoid such a state.

The oscillating actuator in accordance with one aspect of the present invention is an oscillating actuator having a coil arranged within a tubular housing and a magnet arranged within the housing while being surrounded by the coil, the coil and the magnet cooperating with each other so that the magnet oscillates linearly along an axis of oscillation of the housing, the oscillating actuator comprising a shaft, arranged along the axis of oscillation of the housing, having both ends fixed to end walls provided at both ends of the housing in the oscillation axis direction of the housing; a movable element having the magnet adapted to pass the shaft therethrough and movable in an extending direction of the shaft and a weight arranged within the housing, adapted to pass the shaft therethrough, and movable integrally with the magnet; and an elastic member, arranged between the movable element and the end wall, for urging the movable element in the oscillation axis direction; wherein the weight has a bearing part slidable along the shaft; and wherein the movable element is provided with a movement regulator for restraining the magnet from moving radially of the shaft with respect to the weight.

In this oscillating actuator, a movable element having a magnet and a weight oscillates in the extending direction of a shaft, i.e., the oscillation axis direction, while receiving an urging force from an elastic member. Here, the weight has a bearing part slidable with respect to the shaft, whereby the magnet and the shaft have a predetermined gap therebetween. Therefore, the movement regulator restrains the magnet from moving radially of the shaft with respect to the weight having the bearing part. This, in cooperation with the weight having the bearing part, can prevent the magnet from rattling radially of the shaft.

The oscillating actuator may be constructed such that the movable element has a yoke adapted to pass the shaft therethrough and arranged between the magnet and the weight, while the movement regulator restrains the magnet from moving radially of the shaft by a male-female engagement between the weight and the yoke and a male-female engagement between the yoke and the magnet. In this case, the male-female engagements of the members constituting the movable element restrain the magnet from moving radially. Therefore, simply changing the forms of respective joint end faces of the weight, yoke, and magnet can prevent the magnet from rattling. A simple structure can prevent the magnet from rattling.

The yoke may have a first annular part arranged about the shaft and a second annular part located on the outer periphery side of the first annular part and arranged away from the first annular part in the oscillation axis direction. In this case, the first and second annular parts form a depression and projection in the oscillation axis direction. Hence, the male-female engagement between the yoke having such a depression and projection and the respective joint end faces of the weight and magnet can securely restrain the magnet from moving radially.

The movement regulator may restrain the magnet from moving radially by a male-female engagement between the weight and the magnet. In this case, the male-female engagement of the members constituting the movable element restrains the magnet from moving radially. Therefore, simply changing the forms of respective joint end faces of the weight and magnet can prevent the magnet from rattling. A simple structure can prevent the magnet from rattling.

A gap may be formed between the magnet and the shaft. This can securely prevent the magnet from coming into contact with the shaft.

The oscillating actuator may be constructed such that the weight has a smaller diameter part at least partly surrounded by the coil, while the smaller diameter part and the magnet have a length in the oscillation axis direction longer than that of the coil in the oscillation axis direction. When the weight and magnet are inserted into the coil from one end in the oscillation axis direction of the coil, the magnet is exposed from the other end of the coil in the oscillation axis direction. This makes it easier to assemble parts thereafter.

### Advantageous Effects of Invention

One aspect of the present invention can improve the resistance to drop impact while securing stable oscillations. One aspect of the present invention can secure stable oscillations by preventing the magnet from rattling radially of the shaft.

### BRIEF DESCRIPTION OF DRAWINGS

FIG. 1 is a perspective view illustrating a first embodiment of the oscillating actuator;

FIG. 2 is a perspective longitudinal sectional view of the oscillating actuator of FIG. 1;

FIG. 3 is a longitudinal sectional view of the oscillating actuator of FIG. 1;

FIG. 4 is an exploded sectional view of the oscillating actuator of FIG. 1;

FIG. 5 is a longitudinal sectional view illustrating a second embodiment of the oscillating actuator;

FIG. 6 is a longitudinal sectional view illustrating a third embodiment of the oscillating actuator;

FIG. 7 is a longitudinal sectional view illustrating a fourth embodiment of the oscillating actuator;

FIG. 8 is a perspective view of the oscillating actuator of FIG. 7;

FIG. 9 is an exploded perspective view of a movable element in FIG. 7;

FIG. 10 is a sectional view illustrating a magnet and its vicinity in FIG. 7 under magnification;

FIG. 11 is a longitudinal sectional view illustrating a fifth embodiment of the oscillating actuator;

FIG. 12 is a longitudinal sectional view illustrating a sixth embodiment of the oscillating actuator;

FIG. 13 is a longitudinal sectional view illustrating a seventh embodiment of the oscillating actuator;

FIG. 14 is a longitudinal sectional view illustrating an eighth embodiment of the oscillating actuator;

FIG. 15 is a longitudinal sectional view illustrating a ninth embodiment of the oscillating actuator;

FIG. 16 is a longitudinal sectional view illustrating a tenth embodiment of the oscillating actuator;

FIG. 17 is a longitudinal sectional view illustrating an eleventh embodiment of the oscillating actuator;

FIG. 18 is a longitudinal sectional view illustrating a twelfth embodiment of the oscillating actuator;

FIG. 19 is a perspective view illustrating a thirteenth embodiment of the oscillating actuator; and

FIG. 20 is a perspective view illustrating another embodiment of the movable element.

### DESCRIPTION OF EMBODIMENTS

In the following, embodiments of the present invention will be explained in detail with reference to the drawings. In the drawings, the same or equivalent parts will be referred to with the same signs while omitting their overlapping descriptions.

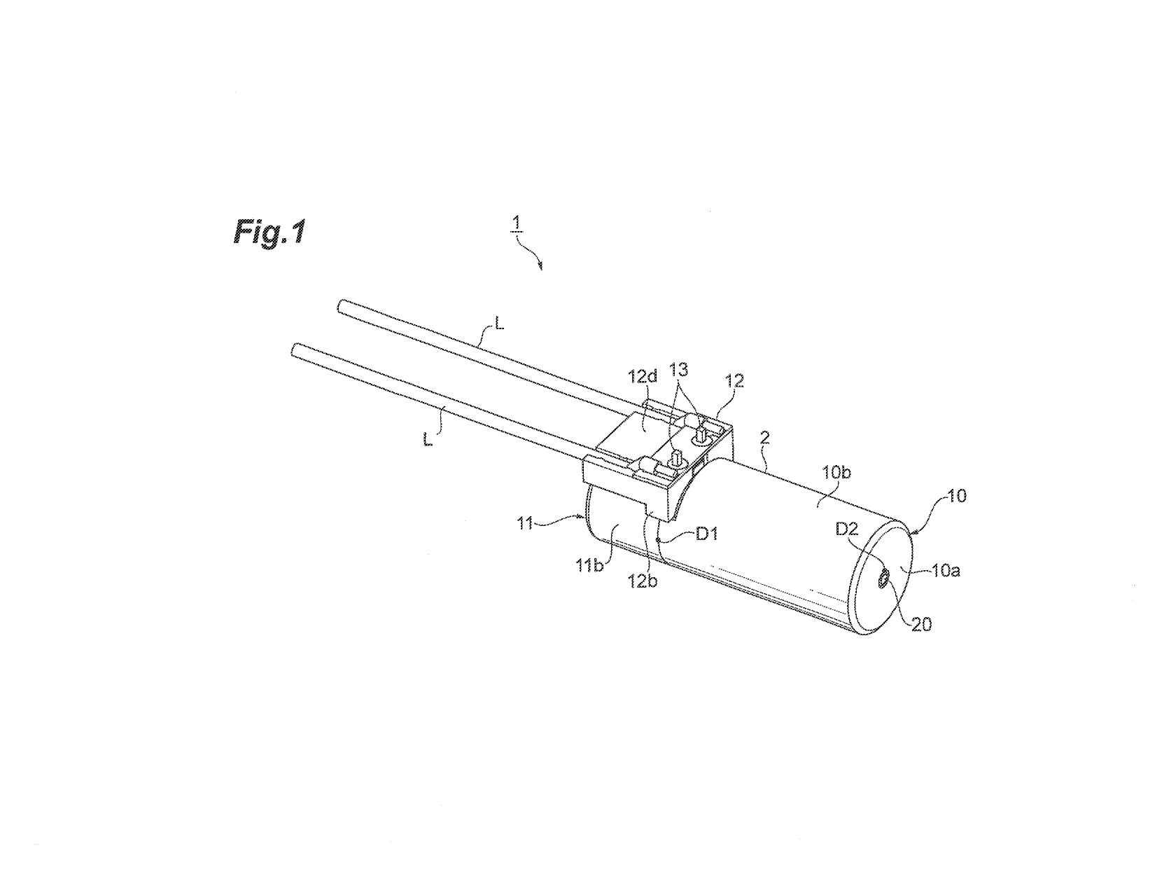

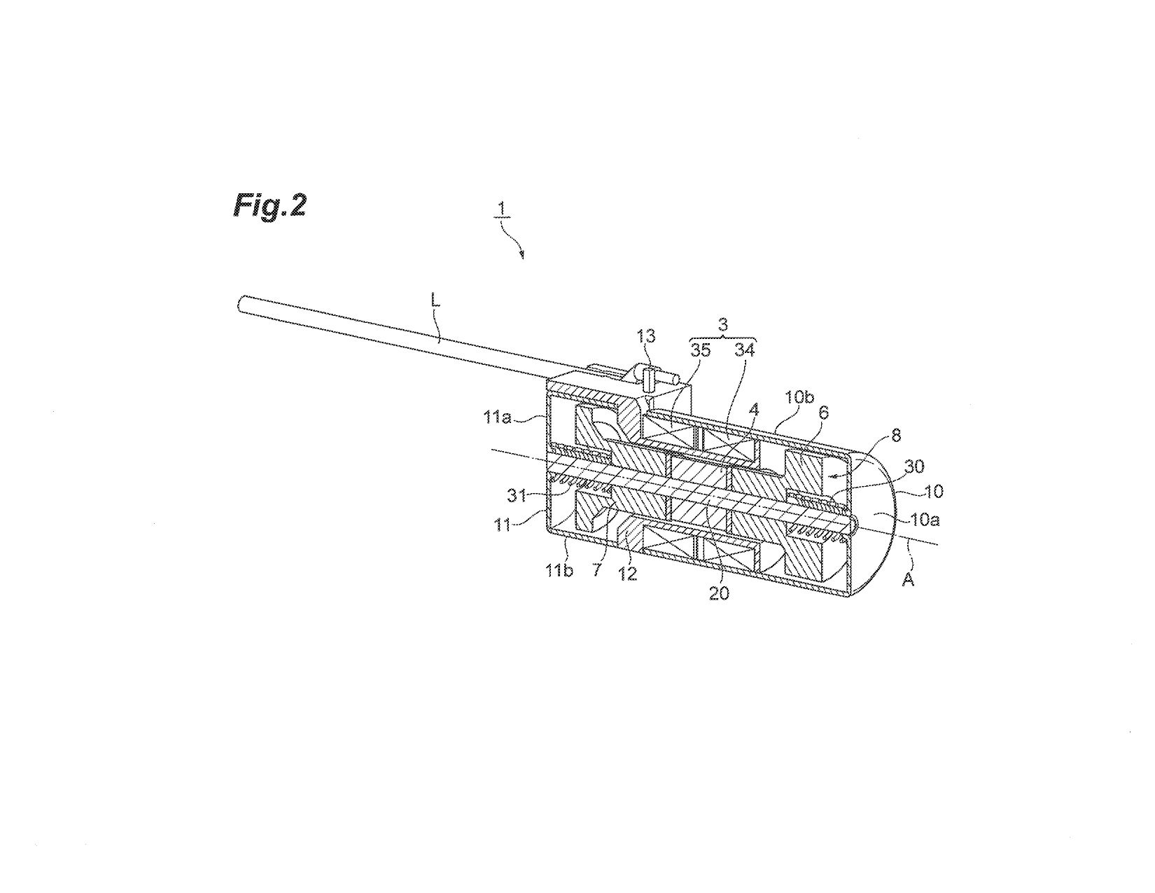

As illustrated in FIGS. 1 to 4, an oscillating actuator 1 has a cylindrical housing 2 with a diameter of about 4.5 mm. The housing 2 contains therein a coil 3 wound annularly about an axis of oscillation A of the housing 2, a cylindrical magnet 4 surrounded by the coil 3, and first and second weights 6, 7 arranged adjacent to the magnet 4 on both sides thereof in the oscillation axis A direction of the housing 2. In this oscillating actuator 1, a movable element 8 constituted by the magnet 4 and first and second weights 6, 7 integrally oscillates linearly in the oscillation axis A direction of the housing 2 under the cooperation between the coil 3 and magnet 4.

The housing 2 is split into two in a direction dividing the oscillation axis A. More specifically, a first housing 10 of the housing 2 contains the first weight 6, coil 3, and magnet 4 by a disk-shaped end wall 10a located at one end in the oscillation axis A direction of the housing 2 and a peripheral wall 10b extending cylindrically in the oscillation axis A direction from the end wall 10a. A second housing 11 of the housing 2 is arranged so as to oppose the first housing 10 in the oscillation axis A direction of the housing 2. The second housing 11 contains the second weight 7 by a disk-shaped end wall 11a located at the other end in the oscillation axis A direction of the housing 2 and a peripheral wall 11b extending cylindrically in the oscillation axis A direction from the end wall 11a. The first and second housings 10, 11 are formed from a magnetic material. A terminal block 12d forming a part of a bobbin 12 made of a resin is exposed from between the first and second housings 10, 11.

The bobbin 12 has a tubular part 12a which has a diameter smaller than that of the peripheral walls 10b, 11b of the first and second housings 10, 11 and is adapted to be inserted within the peripheral wall 10b and wound with the coil 3; flanges 12b, 12c provided continuously with both ends in the oscillation axis A direction of the tubular part 12a; and the terminal block 12d extending along the peripheral wall 11b from an end part of the thicker flange 12b. The tubular part 12a is located at substantially the center in the oscillation axis A direction of the housing 2. One flange 12c abuts against the inner peripheral surface of the peripheral wall 10b of the first housing 10. The other flange 12b is exposed from between the peripheral walls 10b, 11b. Terminals 13 are fixed to the terminal block 12d extending on the outer surface side of the peripheral wall 11b.

Respective end parts of the peripheral walls 10b, 11b of the first and second housings 10, 11 are butted against each other at a location excluding the part where the thicker part 12b of the bobbin 12 is exposed, so as to be joined together by several welds D1 (see FIG. 1).

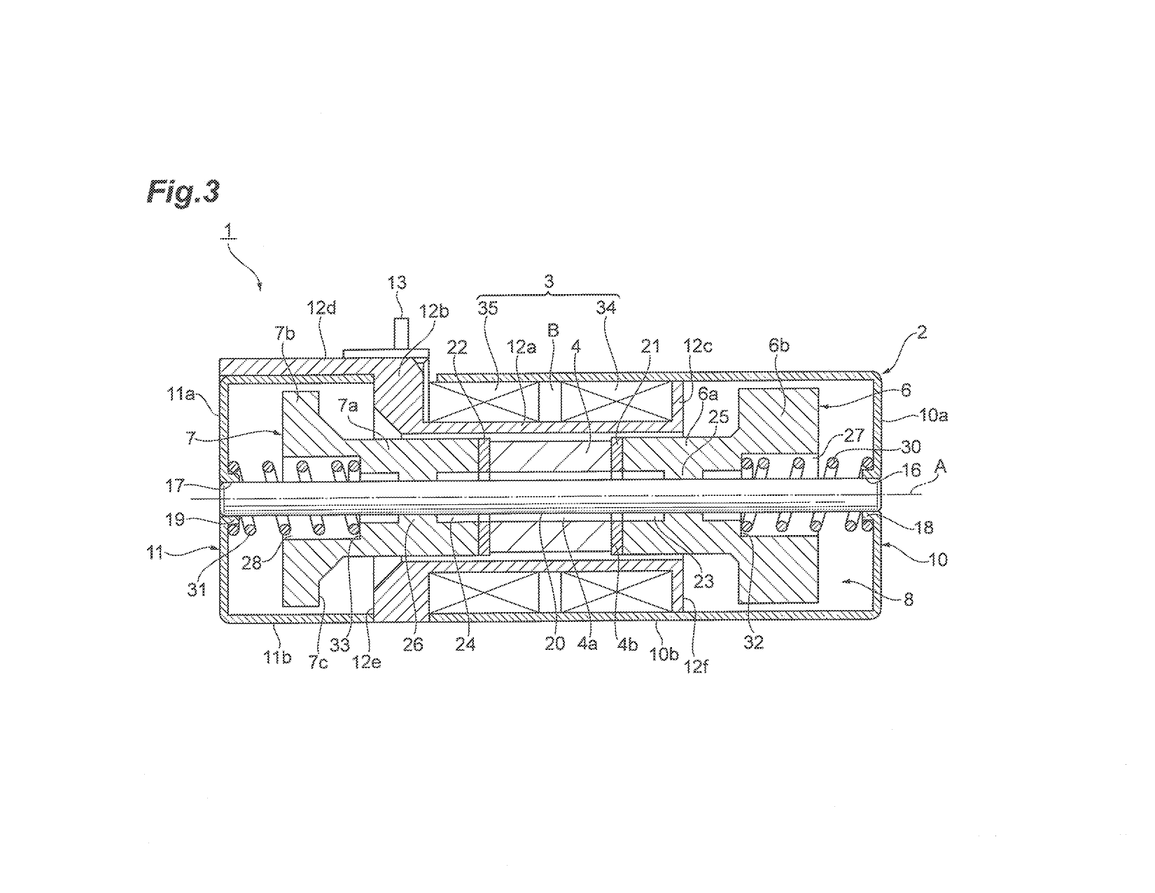

As illustrated in FIG. 3, shaft holding holes 16, 17 are formed at respective center positions of the end walls 10a, 11a. Circular protrusions 18, 19 projecting from the end walls 10a, 11a into the housing 2 are formed about the shaft holding holes 16, 17 by burring. Both ends of a shaft 20 made of a nonmagnetic material having a diameter of about 0.6 mm are press-fitted into the shaft holding holes 16, 17. The end parts of the shaft 20 are fixed to both end walls 10a, 11a by welds D2 (see FIG. 1). Thus, the shaft 20 is arranged along the axis of oscillation A of the housing 2 and strongly joins the first and second housings 10, 11 to each other in the oscillation axis A direction. The shaft 20 penetrates through the movable element 8 constituted by the magnet 4 and first and second weights 6, 7 mentioned above.

When the movable element 8 is explained more specifically, the magnet 4 is magnetized such as to have south and north poles in the oscillation axis A direction. The magnet 4 is formed with a shaft penetration hole 4a having a diameter slightly larger than the outer diameter of the shaft 20. The magnet 4 is arranged within the tubular part 12a of the bobbin 12. Circular pole yokes 21, 22 made of a magnetic material are arranged between the magnet 4 and the first and second weights 6, 7 arranged on both sides of the magnet 4 in the oscillation axis A direction, respectively. The pole yokes 21, 22 are used for efficiently forming a magnetic circuit together with the coil 3, magnet 4, and first housing 10.

The first weight 6 has a barrel 6a inserted from one opening of the tubular part 12a of the bobbin 12 and a flange 6b having a diameter larger than the barrel 6a on the side closer to the end wall 10a of the first housing 10. The second weight 7 has a barrel 7a inserted from the other opening of the tubular part 12a of the bobbin 12 and a flange 7b having a diameter larger than the barrel 7a on the side closer to the end wall 11a of the second housing 11. As the flange 12b of the bobbin 12 is formed thicker, so as to occupy a larger space in the extending direction of the shaft 20, the flange 7b of the second weight 7 is thinner than the flange 6b of the first weight 6 in the extending direction. Forming the weights 6, 7 with the flanges 6b, 7b can make the weights 6, 7 heavier even within the very small housing 2.

The barrels 6a, 7a of the first and second weights 6, 7 are smaller diameter parts having diameters smaller than those of the flanges 6b, 7b, respectively. Respective end parts of the barrels 6a, 7a closer to the magnet 4 are surrounded by the coil 3. That is, at least a part of the barrel 6a is surrounded by the coil 3. At least a part of the barrel 7a is surrounded by the coil 3.

The barrels 6a, 7a of the first and second weights 6, 7 are formed with respective shaft penetration holes 23, 24 each having a diameter slightly larger than the outer diameter of the shaft 20. Bearing parts 25, 26 projecting radially inward like circular rings from the wall faces of the shaft penetration holes 23, 24 are formed in middle parts in the extending direction of the shaft penetration holes 23, 24, so as to be slidable along the shaft 20. In the flanges 6b, 7b of the first and second weights 6, 7, columnar spring receiving holes 27, 28 having diameters larger than the shaft penetration holes 23, 24 of the barrels 6a, 7a are formed coaxially with the shaft penetration holes 23, 24 while communicating therewith.

A first compression coil spring 30 inserted in the spring receiving hole 27 is arranged between the first weight 6 and the end wall 10a. The shaft 20 penetrates through the first compression coil spring 30. A second compression coil spring 31 inserted in the spring receiving hole 28 is arranged between the second weight 7 and the end wall 11a. The shaft 20 penetrates through the second compression coil spring 31. The same parts are used for the first and second compression coil springs 30, 31. The above-mentioned protrusions 18, 19 formed about the shaft holding holes 16, 17 are fitted into respective one ends of the first and second compression coil springs 30, 31. As a consequence, the first and second compression coil springs 30, 31 are securely held without abutting against the shaft 20. On the other hand, the other ends of the first and second compression coil springs 30, 31 are inserted in the spring receiving holes 27, 28 of the first and second weights 6, 7, respectively. The other ends of the first and second compression coil springs 30, 31 abut against respective circular stages 32, 33 formed between the spring receiving holes 27, 28 and the shaft penetration holes 23, 24.

Because of the foregoing structure, the first and second weights 6, 7, pole yokes 21, 22, and magnet 4 in a coaxially arranged state are urged in the oscillation axis A direction by the first and second compression coil springs 30, 31 and joined to one another by these urging forces, so as to be integrated. Therefore, the first and second weights 6, 7, pole yokes 21, 22, and magnet 4 can be joined to one another without adhesives. The movable element 8 constructed by these parts is freely movable in the oscillation axis A direction along the shaft 20 while receiving the urging forces caused by the first and second compression coil springs 30, 31 from both sides.

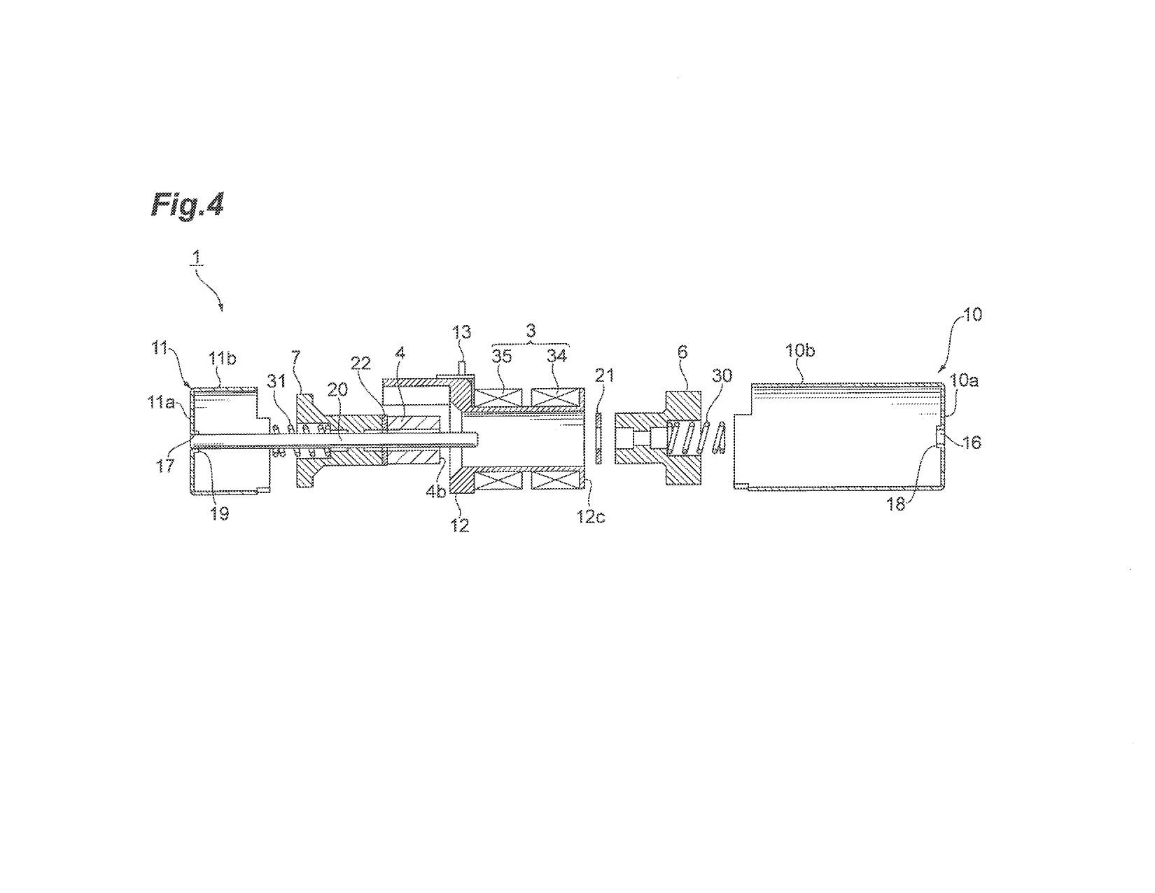

On the magnet 4 side, the flange 7b is formed with a circular end face 7c extending perpendicularly to the extending direction of the shaft 20. The end face 7c opposes an end face 12e of the flange 12b of the bobbin 12 on the end wall 11a side. The length from the end face 7c of the flange 7b to an end face 4b of the magnet 4 on the end wall 10a side is substantially equal to the length from the end face 12e of the flange 12b to an end face 12f of the flange 12c on the end wall 10a side. Due to such a structure, as illustrated in FIG. 4, when press-fitting the shaft 20 into the second housing 11, superposing the second compression coil spring 31, second weight 7, pole yoke 22, and magnet 4 on one another about the shaft 20 passing therethrough, and inserting them into the bobbin 12 being attached to the second housing 11 at the time of assembling the oscillating actuator 1, the end face 4b of the magnet 4 is exposed from the opening of the flange 12c. This makes it easier to assemble the pole yoke 21 and the first weight 6 thereafter.

In other words, the barrel 7a of the second weight 7 and the magnet 4 have a length in the oscillation axis A direction longer than that of the coil 3 in the oscillation axis A direction. As a consequence, when the second weight 7 and magnet 4 are inserted into the coil 3 from one end of the coil 3 in the oscillation axis A direction, the magnet 4 is exposed from the other end of the coil 3 in the oscillation axis A direction. This makes it easier to assemble parts.

On the other hand, the coil 3 wound about the tubular part 12a of the bobbin 12 is constituted by first and second coils 34, 35 arranged in parallel with each other with some gap therebetween in the oscillation axis A direction. The first and second coils 34, 35 are surrounded by the peripheral wall 10b so as to be inscribed therein. That is, the first and second coils 34, 35 are arranged within a space B surrounded by the tubular part 12a of the bobbin 12 and the peripheral wall 10b. Respective currents directed opposite to each other flow through the first and second coils 34, 35 in their winding directions.

When the coil is energized through leads L and the terminals 13 from the outside in thus constructed oscillating actuator 1, a magnetic field is formed by the coils 34, 35, and the magnet 4 is attracted to or repulsed from this magnetic field, so that the first and second weights 6, 7, pole yokes 21, 22, and magnet 4 integrally oscillate linearly in the oscillation axis A direction, so as to generate oscillations in a device such as a mobile phone equipped with the oscillating actuator 1.

In the oscillating actuator 1, the shaft 20 having respective ends fixed to the end walls 10a, 11a penetrates through the magnet 4 and weights 6, 7, whereby the magnet 4 and weights 6, 7 oscillate integrally while being guided by the fixed shaft 20. This prevents the weights 6, 7 from shifting their center of gravity positions from the axis of oscillation A and running wild, whereby stable oscillations can be secured. It also prevents the weights 6, 7 from colliding with the housing 2 even under drop impact and thus can improve the resistance to drop impact. The housing 2 is split into two in a direction dividing the axis of oscillation A as with the housing 2 constituted by the first and second housings 10, 11. The shaft 20 having both ends fixed to the respective end walls 10a, 11a of the housing 2 functions as a joint bar. This enhances the strength of joining the first and second housings 10, 11 constituting the housing 2. This can avoid a state where the housing 2 is split in the oscillation axis A direction under drop impact so as to eject the weights 6, 7 and magnet 4 out of the housing 2.

Since the first and second coils 34, 35 have respective current flowing directions different from each other, a magnetic path directed from the magnet 4 to the first coil 34 and a magnetic path returning from the second coil 35 to the magnet 4 are formed, so that a thrust can be generated by both magnetic paths. Therefore, a greater thrust can be obtained as compared with a case using a single coil.

Since the weights 6, 7, pole yokes 21, 22, and magnet 4 oscillate while receiving urging forces from the first and second compression coil springs 30, 31 from both sides, stable oscillations can be obtained securely and easily. By employing the compression coil springs 30, 31 opposing each other, the weights 6, 7, pole yokes 21, 22, and magnet 4 are joined to one another in the oscillation axis A direction so as to be integrated, whereby the parts can be joined together without using adhesives. Since the shaft 20 penetrates through the weights 6, 7, magnet 4, and pole yokes 21, 22 in particular, a protruded excess of an adhesive, if any, and the shaft 20 may slide on each other, so as to produce frictional resistance. However, the oscillating actuator 1 can avoid such a state.

Since the first and second weights 6, 7 arranged on both sides of the magnet 4 in the oscillation axis A direction are provided, further stable oscillations can be secured. Since the first and second weights 6, 7 are formed with the respective bearing parts 25, 26, oscillations with a favorable balance can be obtained along the shaft 20. Since the bearing parts 25, 26 are formed in only a part of the shaft penetration holes 23, 24 in their extending direction, frictional forces occurring upon oscillations of the movable element 8 can be made as low as possible.

Since the peripheral wall 10b of the first housing 10 also serves as a yoke plate for forming a magnetic circuit, it is not necessary to separately prepare a yoke plate for surrounding the coils 34, 35, whereby a smaller size is achieved radially. Since the first and second compression coil springs 30, 31 are parts identical to each other, parts are commoditized.

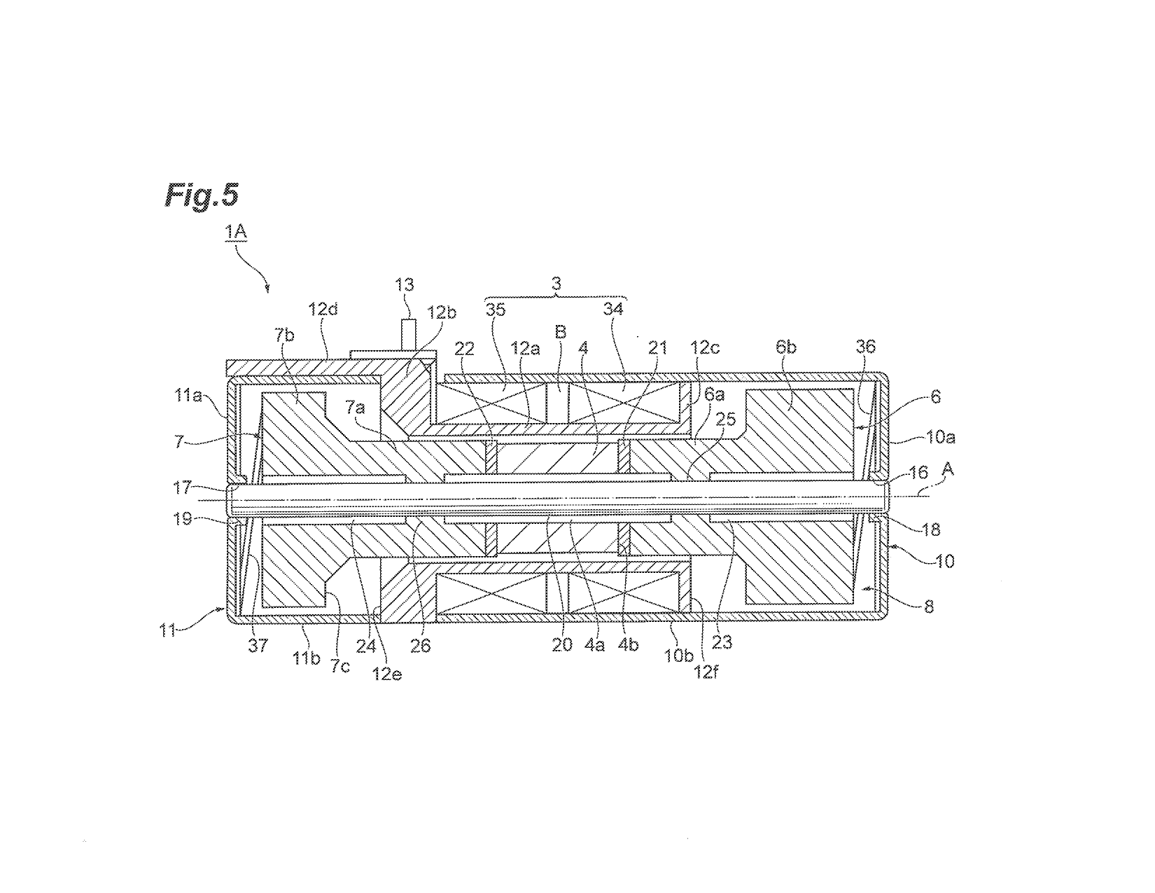

FIG. 5 is a longitudinal sectional view of an oscillating actuator 1A in accordance with the second embodiment. As illustrated in FIG. 5, the oscillating actuator 1A uses leaf springs 36, 37 in place of the first and second coil springs 30, 31 in the oscillating actuator 1 (see FIG. 3) of the first embodiment. This makes it unnecessary for the flanges 6b, 7b of the first and second weights to be provided with spring receiving holes, whereby the weights 6, 7 can be made heavier. Thus constructed oscillating actuator 1A can also exhibit the same operations and effects as with the oscillating actuator 1.

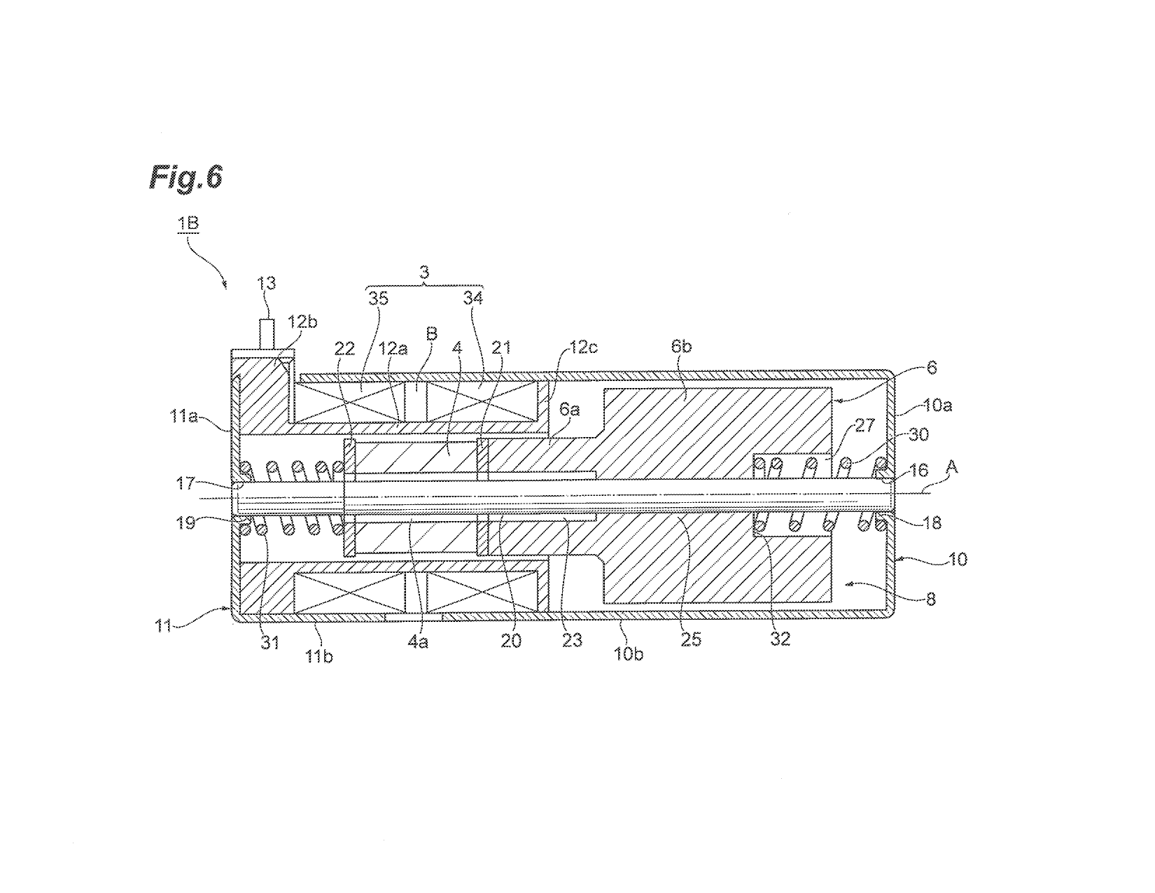

FIG. 6 is a longitudinal sectional view of an oscillating actuator 1B in accordance with the third embodiment. As illustrated in FIG. 6, the oscillating actuator 1B lacks the second weight 7 in the oscillating actuator 1 (see FIG. 3) of the first embodiment and is equipped with the first weight 6 having enhanced its volume correspondingly. Due to this change, the positions where the magnet 4 and coils 34, 35 are provided are shifted toward the end wall 11a in the oscillation axis A direction. The shaft penetration hole 23 and the spring receiving hole 27 do not communicate with each other, while a large bearing part 25 is disposed therebetween. Thus constructed oscillating actuator 1B can secure stable oscillations and improve the resistance to drop impact as with the oscillating actuator 1.

While the first to third embodiments of the present invention are explained in the foregoing, the present invention is not limited thereto. For example, an elastic member such as a spring for urging the movable element 8 may be provided on not both sides but only one side of the movable element 8 and coupled to the end wall and movable element. The elastic member is not limited to the compression coil springs and leaf springs but may be tension coil springs coupled to the end walls and movable element. The housing may be split into two or more.

While the above-mentioned embodiments relate to a case where the first and second weights 6, 7, pole yokes 21, 22, and magnet 4 are joined to one another without using adhesives, they may be joined together with adhesives. When assembling the oscillating actuator, the end face 4b of the magnet 4 inserted in the bobbin 12 is also exposed from the opening in the flange 12c of the bobbin 12 in the latter case as mentioned above, whereby the pole yoke 21 and second weight 6 can be bonded securely and easily.

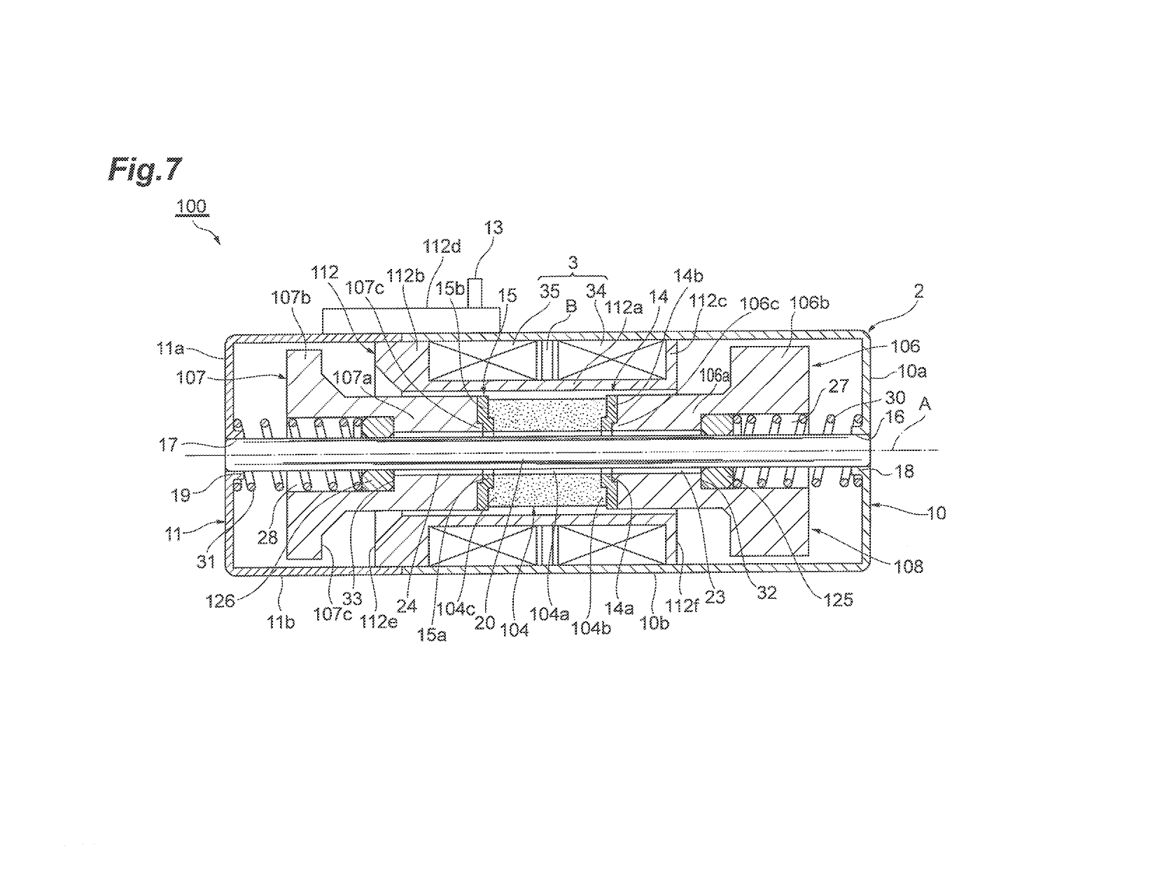

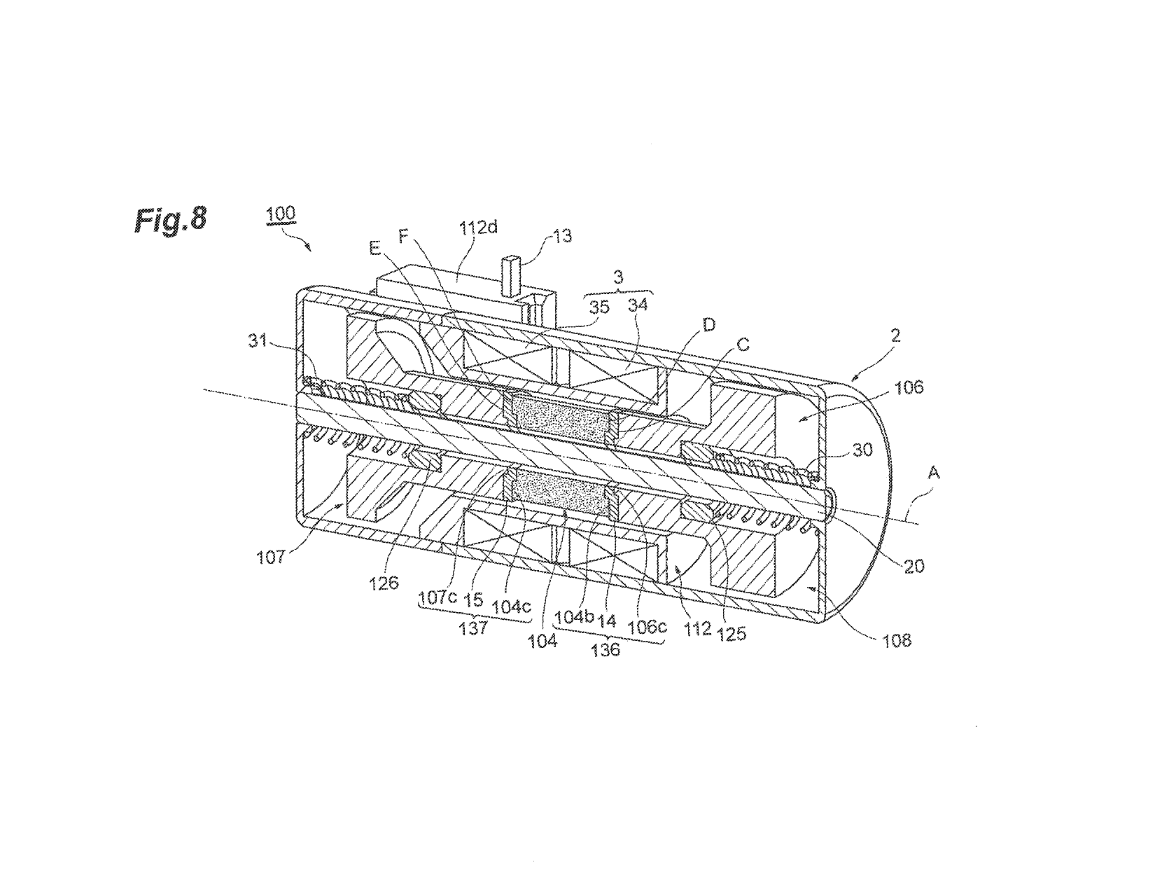

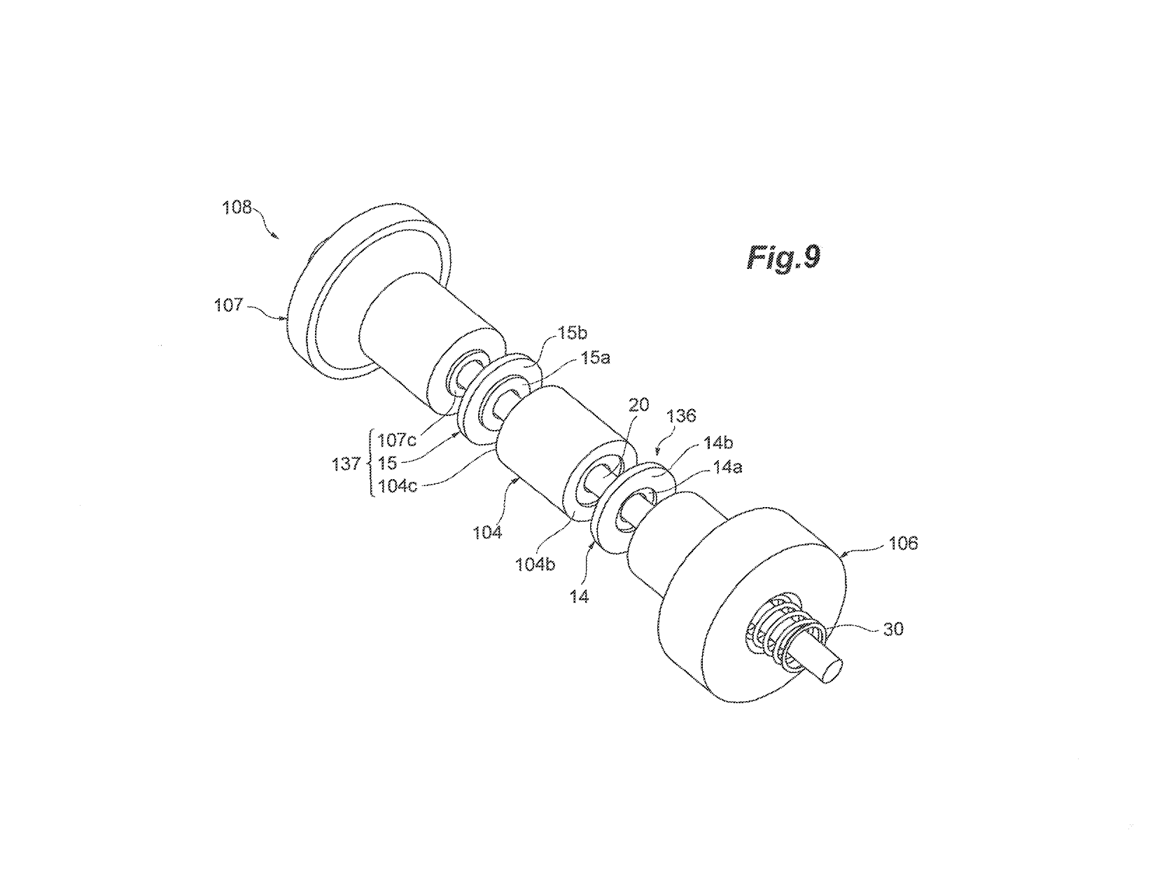

FIG. 7 is a longitudinal sectional view illustrating the fourth embodiment of the oscillating actuator. FIG. 8 is a perspective view of the oscillating actuator of FIG. 7. FIG. 9 is an exploded perspective view of the movable element in FIG. 7.

As illustrated in FIGS. 7 to 9, this oscillating actuator 100 has a cylindrical housing 2 with a diameter of about 4.5 mm. The housing 2 contains therein a coil 3 annularly wound about the axis of oscillation A of the housing 2, a cylindrical magnet 104 surrounded by the coil 3, and first and second weights 106, 107 disposed on both sides of the magnet 104 in the oscillation axis A direction of the housing 2. Circular pole yokes 14, 15 made of a magnetic material are arranged between the magnet 104 and the first and second weights 106, 107, respectively. The pole yokes 14, 15 are used for efficiently forming a magnetic circuit together with the coil 3, magnet 104, and first housing 10.

In the oscillating actuator 100, the movable element 108 constituted by the magnet 104, first and second weights 106, 107, and pole yokes 14, 15 integrally oscillates linearly along the oscillation axis A direction of the housing 2 under the cooperation between the coil 3 and magnet 104.

The housing 2 is split into two in a direction dividing the oscillation axis A. More specifically, a first housing 10 of the housing 2 contains the first weight 106, coil 3, magnet 104, and pole yokes 14, by a disk-shaped end wall 10a located at one end in the oscillation axis A direction of the housing 2 and a peripheral wall 10b extending cylindrically in the oscillation axis A direction from the end wall 10a. A second housing 11 of the housing 2 is arranged so as to oppose the first housing 10 in the oscillation axis A direction of the housing 2. The second housing 11 contains the second weight 107 by a disk-shaped end wall 11a located at the other end in the oscillation axis A direction of the housing 2 and a peripheral wall 11b extending cylindrically in the oscillation axis A direction from the end wall 11a. The first and second housings 10, 11 are formed from a magnetic material. A terminal block 112d forming a part of a bobbin 112 made of a resin is exposed from between the first and second housings 10, 11.

The bobbin 112 has a tubular part 112a which has a diameter smaller than that of the peripheral walls 10b, 11b of the first and second housings 10, 11 and is adapted to be inserted within the peripheral wall 10b and wound with the coil 3; flanges 112b, 112c provided continuously with both ends in the oscillation axis A direction of the tubular part 112a; and the terminal block 112d continuously provided with the thick flange 112b so as to project from the housing 2. The tubular part 112a is located at substantially the center in the oscillation axis A direction of the housing 2. One flange 112c abuts against the inner peripheral surface of the peripheral wall 10b of the first housing 10. The other flange 112b, which is thicker, abuts against the inner peripheral surface of each of the end parts of the peripheral walls 10b, 11b. Terminals 13, to which end parts of the coil 3 are bound, are fixed to the terminal block 112d.

Respective end parts of the peripheral walls 10b, 11b of the first and second housings 10, 11 are butted against each other at a location excluding the part where the terminal block 112d of the bobbin 112 is exposed, so as to be joined together by several welds.

Shaft holding holes 16, 17 are formed at respective center positions of the end walls 10a, 11a. Circular protrusions 18, 19 projecting from the end walls 10a, 11a into the housing 2 are formed about the shaft holding holes 16, 17 by burring. Both ends of a shaft 20 made of a nonmagnetic material having a diameter of about 0.6 mm are press-fitted into the shaft holding holes 16, 17. The end parts of the shaft 20 are fixed to both end walls 10a, 11a by welds D2 (see FIG. 1). Thus, the shaft 20 is arranged along the axis of oscillation A of the housing 2 and strongly joins the first and second housings 10, 11 to each other in the oscillation axis A direction. The shaft 20 penetrates through the movable element 108 constituted by the magnet 104, first and second weights 106, 107 and pole yokes 14, 15 mentioned above.

When the movable element 108 is explained more specifically, the magnet 104 is magnetized such as to have south and north poles in the oscillation axis A direction. The magnet 104 is formed with a shaft penetration hole 104a having a diameter slightly larger than the outer diameter of the shaft 20. The magnet 104 is arranged within the tubular part 112a of the bobbin 112.

The first weight 106 has a barrel 106a inserted from one opening of the tubular part 112a of the bobbin 112 and a flange 106b having a diameter larger than the barrel 106a on the side closer to the end wall 10a of the first housing 10. The second weight 107 has a barrel 107a inserted from the other opening of the tubular part 112a of the bobbin 112 and a flange 107b having a diameter larger than the barrel 107a on the side closer to the end wall 11a of the second housing 11. As the flange 112b of the bobbin 112 is formed thicker, so as to occupy a larger space in the extending direction of the shaft 20, the flange 107b of the second weight 107 is thinner than the flange 106b of the first weight 106 in the extending direction. Forming the weights 106, 107 with the flanges 106b, 107b can make the weights 106, 107 heavier even within the very small housing 2.

The barrels 106a, 107a of the first and second weights 106, 107 are smaller diameter parts having diameters smaller than those of the flanges 106b, 107b, respectively. Respective end parts of the barrels 106a, 107a closer to the magnet 104 are surrounded by the coil 3. That is, at least a part of the barrel 106a is surrounded by the coil 3. At least a part of the barrel 107a is surrounded by the coil 3.

The barrels 106a, 107a of the first and second weights 106, 107 are formed with respective shaft penetration holes 23, 24 each having a diameter slightly larger than the outer diameter of the shaft 20. In the flanges 106b, 107b of the first and second weights 106, 107, columnar spring receiving holes 27, 28 having diameters larger than the shaft penetration holes 23, 24 of the barrels 106a, 107a are formed coaxially with the shaft penetration holes 23, 24 while communicating therewith.

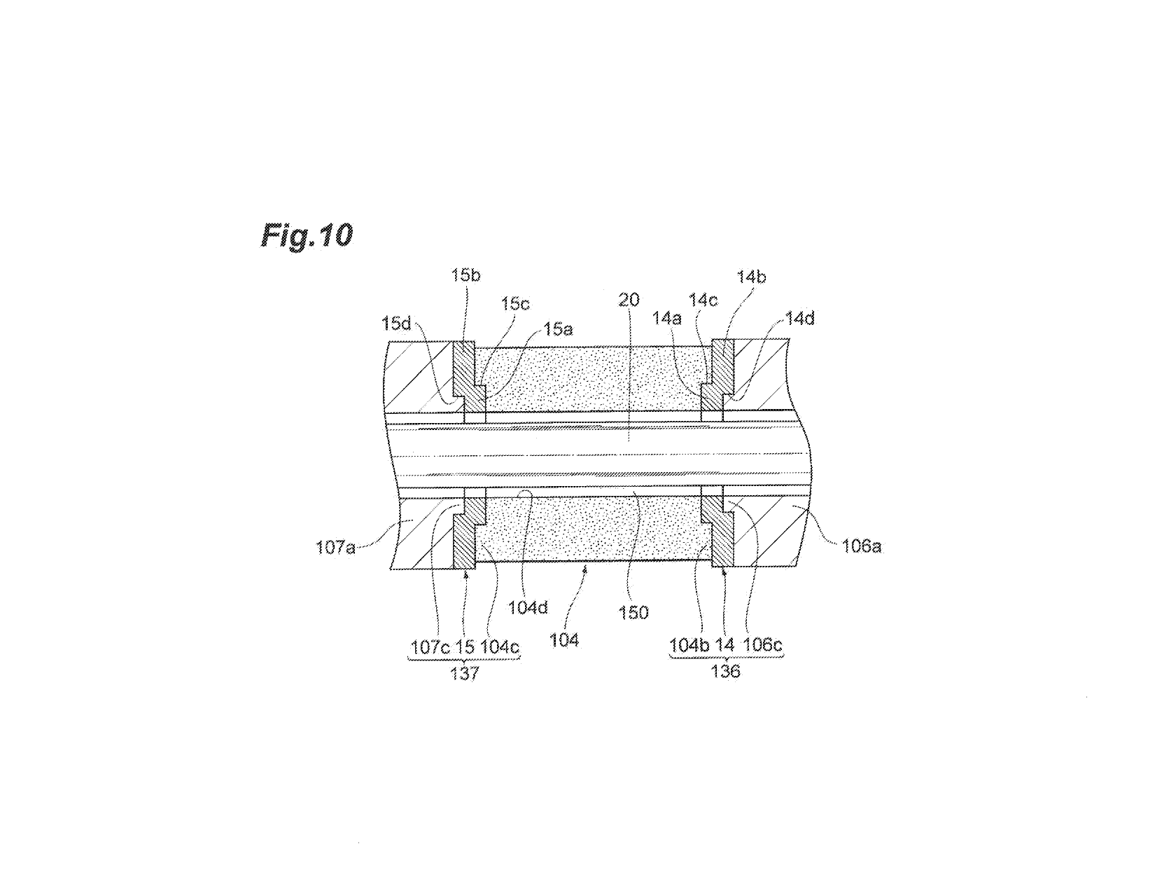

Cylindrical bearings (bearing parts) 125, 126 are press-fitted in the spring receiving holes 27, 28, respectively. The bearings 125, 126 have respective outer peripheral surfaces abutting against the peripheral surfaces of the spring receiving holes 27, 28 and inner peripheral surfaces abutting against the shaft 20. The end faces of the bearings 125, 126 on the magnet 104 side abut against circular stages 32, 33 formed between the spring receiving holes 27, 28 and the shaft penetration holes 23, 24, respectively. While supporting the first and second weights 106, 107, the bearings 125, 126 slide along the shaft 20. The first and second weights 106, 107 thus have the above-mentioned bearings 125, 126, respectively, whereby a predetermined gap 150 (see FIG. 10) is provided between the shaft 20 and the magnet 104 and pole yokes 14, 15.

A first compression coil spring 30 inserted in the spring receiving hole 27 is arranged between the first weight 106 and the end wall 10a. The shaft 20 penetrates through the first compression coil spring 30. A second compression coil spring 31 inserted in the spring receiving hole 28 is arranged between the second weight 107 and the end wall 11a. The shaft 20 penetrates through the second compression coil spring 31. The same parts are used for the first and second compression coil springs 30, 31.

The above-mentioned protrusions 18, 19 formed about the shaft holding holes 16, 17 are fitted into respective ends of the first and second compression coil springs 30, 31. As a consequence, the first and second compression coil springs 30, 31 are securely held without abutting against the shaft 20. On the other hand, the other ends of the first and second compression coil springs 30, 31 are inserted in the spring receiving holes 27, 28 of the first and second weights 106, 107, respectively. The other ends of the first and second compression coil springs 30, 31 are pressed against the above-mentioned bearings 125, 126, respectively.

In the oscillating actuator 100, the magnet 104 of the movable element 108 is restrained from moving radially of the shaft 20 with respect to the first and second weights 106, 107. Specifically, the circular pole yoke 14 has a first annular part 14a arranged about the shaft 20 and a second annular part 14b located on the outer periphery side of the first annular part 14a and arranged away from the first annular part 14a toward the end wall 10a in the oscillation axis A direction. The circular pole yoke 15 has a first annular part 15a arranged about the shaft 20 and a second annular part 15b located on the outer periphery side of the first annular part 15a and arranged away from the first annular part 15a toward the end wall 11a in the oscillation axis A direction.

As illustrated in FIG. 10, ring-shaped stepped surfaces 14c, 15c facing radially outward of the shaft 20 are formed closer to the magnet 104 between the respective first annular parts 14a, 15a and second annular parts 14b, 15b. Ring-shaped stepped surfaces 14d, 15d facing radially inward of the shaft 20 are respectively formed on the sides closer to the first and second weights 106, 107 between the first annular parts 14a, 15a and second annular parts 14b, 15b. Thus, each of the pole yokes 14, 15 has a stepped form at a boundary of annular parts with different diameters, thereby yielding a depression and projection in the extending direction of the shaft 20. As the pole yokes 14, 15, parts identical to each other are employed, whereby parts are commoditized.

Circular protrusions 104b, 104c abutting against their corresponding stepped surfaces 14c, 15c and second annular parts 14b, 15b are formed at respective ends of the magnet 104. The barrel 106a of the first weight 106 is formed with a columnar projection 106c which abuts against the stepped surface 14d and first annular part 14a. The barrel 107a of the second weight 107 is formed with a columnar projection 107c which abuts against the stepped surface 15d and first annular part 15a.

In other words, as illustrated in FIG. 8, each of the joint end face C between the first weight 106 and the pole yoke 14, the joint end face D between the pole yoke 14 and the magnet 104, the joint end face E between the second weight 107 and the pole yoke 15, and the joint end face F between the pole yoke 15 and the magnet 104 is formed into a stepped circle.

Thus, the first weight 106 and the magnet 104 are in male-female engagement with the pole yoke 14, while the second weight 107 and the magnet 104 are in male-female engagement with the pole yoke 15. These male-female engagements restrain the magnet 104 from moving radially of the shaft 20 with respect to the first and second weights 106, 107 having the bearings 125, 126. The pole yoke 14 and projections 104b, 106c construct a movement regulator 136, while the pole yoke 15 and projections 104c, 107c construct a movement regulator 137 (see FIGS. 8 and 9).

Because of the foregoing structure, the first and second weights 106, 107, pole yokes 14, 15, and magnet 104 in a coaxially arranged state are urged in the oscillation axis A direction by the first and second compression coil springs 30, 31 and joined to one another under pressure by these urging forces, so as to be integrated. In addition, the movement regulators 136, 137 center the first and second weights 106, 107, pole yokes 14, 15, and magnet 104 onto the same axis. This prevents the magnet 104 and pole yokes 14, 15 from shifting radially of the shaft 20. The gap 150 (i.e., interval 150) is formed between the inner wall 104d of the magnet 104 and the shaft 20. This prevents the magnet 104 and pole yokes 14, 15 from coming into contact with the shaft 20. The first and second weights 106, 107, pole yokes 14, 15, and magnet 104 can also be joined to one another without adhesives.

On the magnet 104 side, the flange 107b is formed with a circular end face 107c extending perpendicularly to the extending direction of the shaft 20. The end face 107c opposes an end face 112e of the flange 112b of the bobbin 112 on the end wall 11a side. The length from the end face 107c of the flange 107b to an end face 104b of the magnet 104 on the end wall 10a side is substantially equal to the length from the end face 112e of the flange 112b to an end face 112f of the flange 112c on the end wall 10a side. Due to such a structure, when press-fitting the shaft 20 into the second housing 11, superposing the second compression coil spring 31, bearing 126, second weight 107, pole yoke 15, and magnet 104 on one another about the shaft 20 passing therethrough, and inserting them into the bobbin 112 being attached to the second housing 11 at the time of assembling the oscillating actuator 100, the end face 104b of the magnet 104 is exposed from the opening of the flange 112c. This makes it easier to assemble the pole yoke 14 and the first weight 106 thereafter.

In other words, the barrel 107a of the second weight 107 and the magnet 104 have a length in the oscillation axis A direction longer than that of the coil 3 in the oscillation axis A direction. As a consequence, when the second weight 107 and magnet 104 are inserted into the coil 3 from one end of the coil 3 in the oscillation axis A direction, the magnet 104 is exposed from the other end of the coil 3 in the oscillation axis A direction. This makes it easier to assemble parts.

On the other hand, the coil 3 wound about the tubular part 112a of the bobbin 112 is constituted by first and second coils 34, 35 arranged in parallel with each other with some gap therebetween in the oscillation axis A direction. The first and second coils 34, 35 are surrounded by the peripheral wall 10b so as to be inscribed therein. That is, the first and second coils 34, 35 are arranged within a space B surrounded by the tubular part 112a of the bobbin 112 and the peripheral wall 10b. Respective currents directed opposite to each other flow through the first and second coils 34, 35 in their winding directions.

When the coil is energized through leads L and the terminals 13 from the outside in thus constructed oscillating actuator 100, a magnetic field is formed by the coils 34, 35, and the magnet 104 is attracted to or repulsed from this magnetic field, so that the movable element 108 oscillates linearly in the oscillation axis A direction while supported by the bearings 125, 126 and receiving the urging forces caused by the first and second compression coil springs 30, 31 from both sides. As a consequence, oscillations in a device such as a mobile phone equipped with the oscillating actuator 100 are generated.

Since the first and second weights 106, 107 have the bearings 125, 126 slidable with respect to the shaft 20, a predetermined gap is formed between the magnet 104 and the shaft 20 in the oscillating actuator 100. The movement regulators 136, 137 restrain the magnet 104 from moving radially of the shaft 20 with respect to the first and second weights 106, 107 having the bearings 125, 126. This, in cooperation with the first and second weights 106, 107 having the bearings 125, 126, prevents the magnet 104 from rattling radially of the shaft 20. This secures a clearance between the magnet 104 and the shaft 20, thereby reliably preventing the magnet 104 from coming into contact with the shaft 20.

By the male-female engagements between the first and second weights 106, 107 and the pole yokes 14, 15 and the male-female engagements between the pole yokes 14, 15 and the magnet 104, the movement regulators 136, 137 restrain the magnet 104 from moving radially of the shaft 20. Thus, the male-female engagements between members constituting the movable element 108 restrain the magnet 104 from moving radially. Hence, by changing only the forms of joint end faces (joint end faces C to F in FIG. 8) of the first and second weights 106, 107, pole yokes 14, 15, and magnet 104, a simple structure prevents the magnet 104 from rattling.

The pole yokes 14, 15 have the first annular parts 14a, 15a and the second annular parts 14b, 15b located on the outer periphery side of the first annular parts 14a, 15a and arranged away from the first annular parts 14a, 15a in the oscillation axis A direction. The first annular parts 14a, 15a and second annular parts 14b, 15b form depressions and projections in the oscillation axis A direction. The male-female engagements between the joint end faces of the pole yokes 14, 15 having such depressions and projections and their corresponding joint end faces of the first and second weights 106, 107 and magnet 104 securely restrain the magnet 104 from moving radially.

The shaft 20 having the respective ends fixed to the end walls 10a, 11a of the housing 2 penetrates through the magnet 104 and weights 106, 107, whereby the magnet 104 and weights 106, 107 oscillate integrally. This prevents the weights 106, 107 from shifting their center of gravity positions from the axis of oscillation A and running wild, whereby stable oscillations can be secured. It also prevents the weights 106, 107 from colliding with the housing 2 even under drop impact and thus can improve the resistance to drop impact.

The housing 2 is split into two in a direction dividing the axis of oscillation A. The shaft 20 having both ends fixed to the respective end walls 10a, 11a of the housing 2 functions as a joint bar. This enhances the strength of joining the first and second housings 10, 11 constituting the housing 2. This can avoid a state where the housing 2 is split in the oscillation axis A direction under drop impact so as to eject the weights 106, 107 and magnet 104 out of the housing 2.

Since the weights 106, 107, pole yokes 14, 15, and magnet 104 oscillate while receiving urging forces from the first and second compression coil springs 30, 31 from both sides, stable oscillations can be obtained securely and easily. By employing the compression coil springs 30, 31 opposing each other, the weights 106, 107, pole yokes 14, 15, and magnet 104 are joined to one another in the oscillation axis A direction so as to be integrated, whereby the parts can be joined together without using adhesives. Since the shaft 20 penetrates through the weights 106, 107, magnet 104, and pole yokes 14, 15 in particular, a protruded excess of an adhesive, if any, and the shaft 20 may slide on each other, so as to produce frictional resistance. However, the oscillating actuator 100 can avoid such a state.

Since the first and second weights 106, 107 arranged on both sides of the magnet 104 in the oscillation axis A direction are provided, further stable oscillations can be secured. Since the first and second weights 106, 107 are formed with the respective bearing parts 125, 126, oscillations with a favorable balance can be obtained along the shaft 20.

Since the peripheral wall 10b of the first housing 10 also serves as a yoke plate for forming a magnetic circuit, it is not necessary to separately prepare a yoke plate for surrounding the coils 34, 35, whereby a smaller size is achieved radially. Since the first and second compression coil springs 30, 31 are parts identical to each other, parts are commoditized.

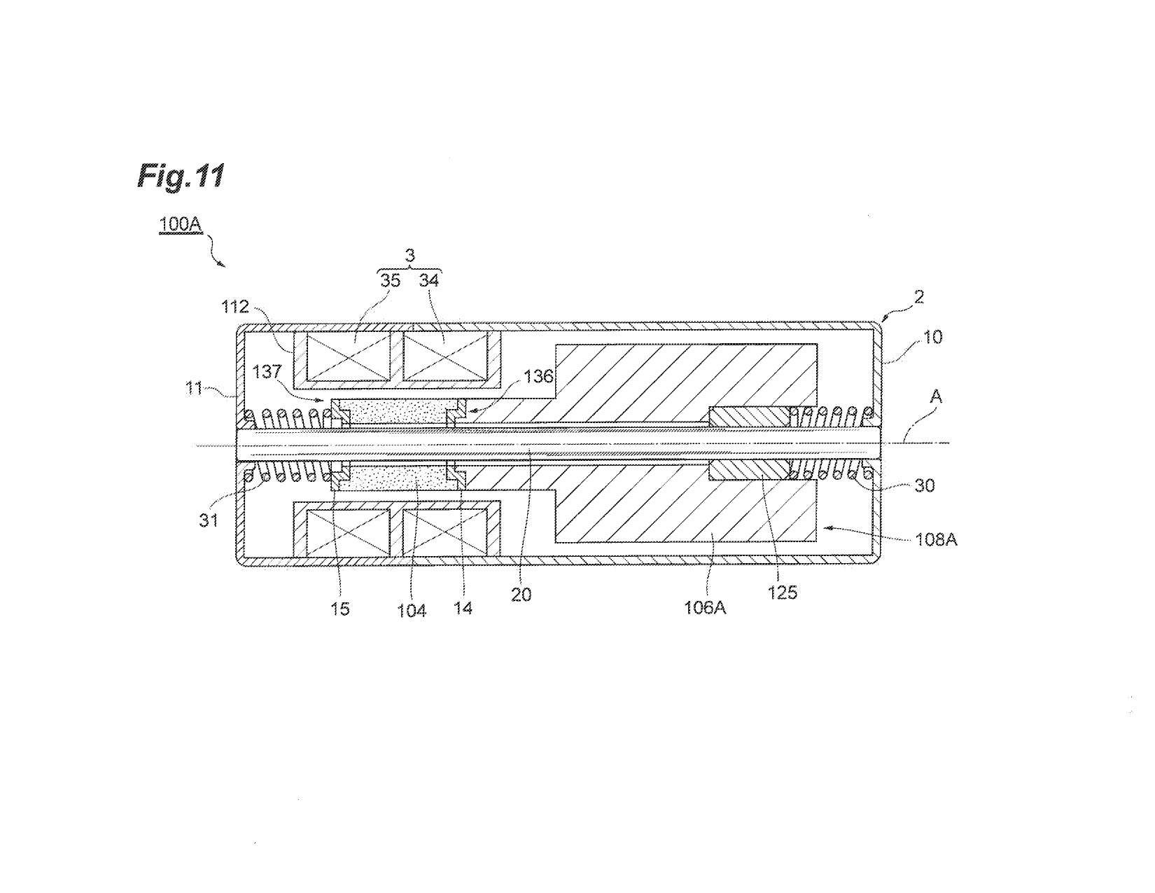

FIG. 11 is a longitudinal sectional view illustrating the fifth embodiment of the oscillating actuator. The oscillating actuator 100A illustrated in FIG. 11 differs from the oscillating actuator 100 in accordance with the fourth embodiment illustrated in FIG. 7 in that it comprises a movable element 108A which lacks the second weight 107, while a first weight 106A is arranged on only one side. The second compression coil spring 31 directly urges the pole yoke 15. This oscillating actuator 100A can also yield the above-mentioned effect of preventing the magnet 104 from rattling and the like.

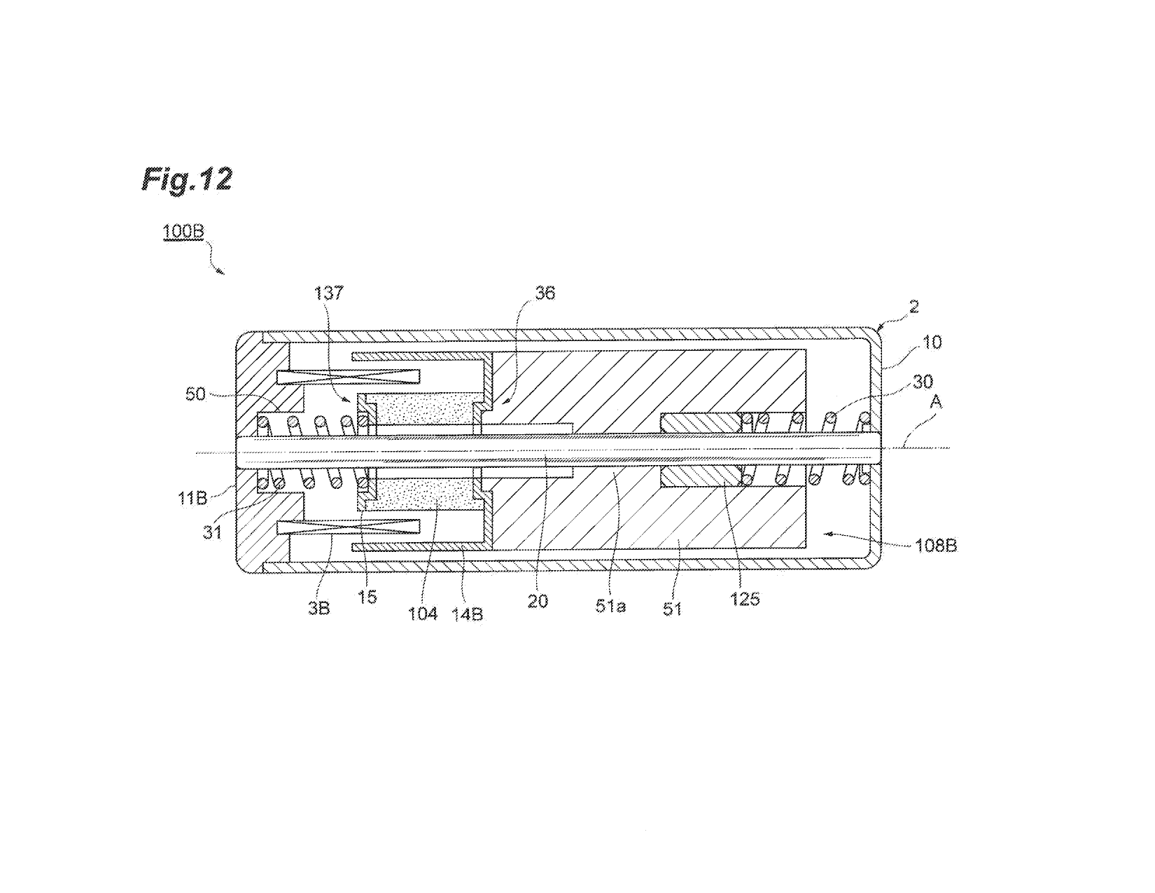

FIG. 12 is a longitudinal sectional view illustrating the sixth embodiment of the oscillating actuator. The oscillating actuator 100B illustrated in FIG. 12 differs from the oscillating actuator 100 in accordance with the fourth embodiment illustrated in FIG. 7 in that it is equipped with a movable element 108B in which a first weight 51 formed with a bearing part 51a is arranged on only one side, while lacking the second weight 107, and a cup-shaped pole yoke 14B is disposed between the first weight 51 and the magnet 104; an air core coil 3B disposed between the pole yoke 14B and the magnet 104, while lacking the bobbin 112, in place of the coil 3; and a second housing 11B formed with a depression 50 for seating the second compression coil spring 31 stably. This oscillating actuator 100B can also yield the above-mentioned rattling prevention effect for the magnet 104 and the like.

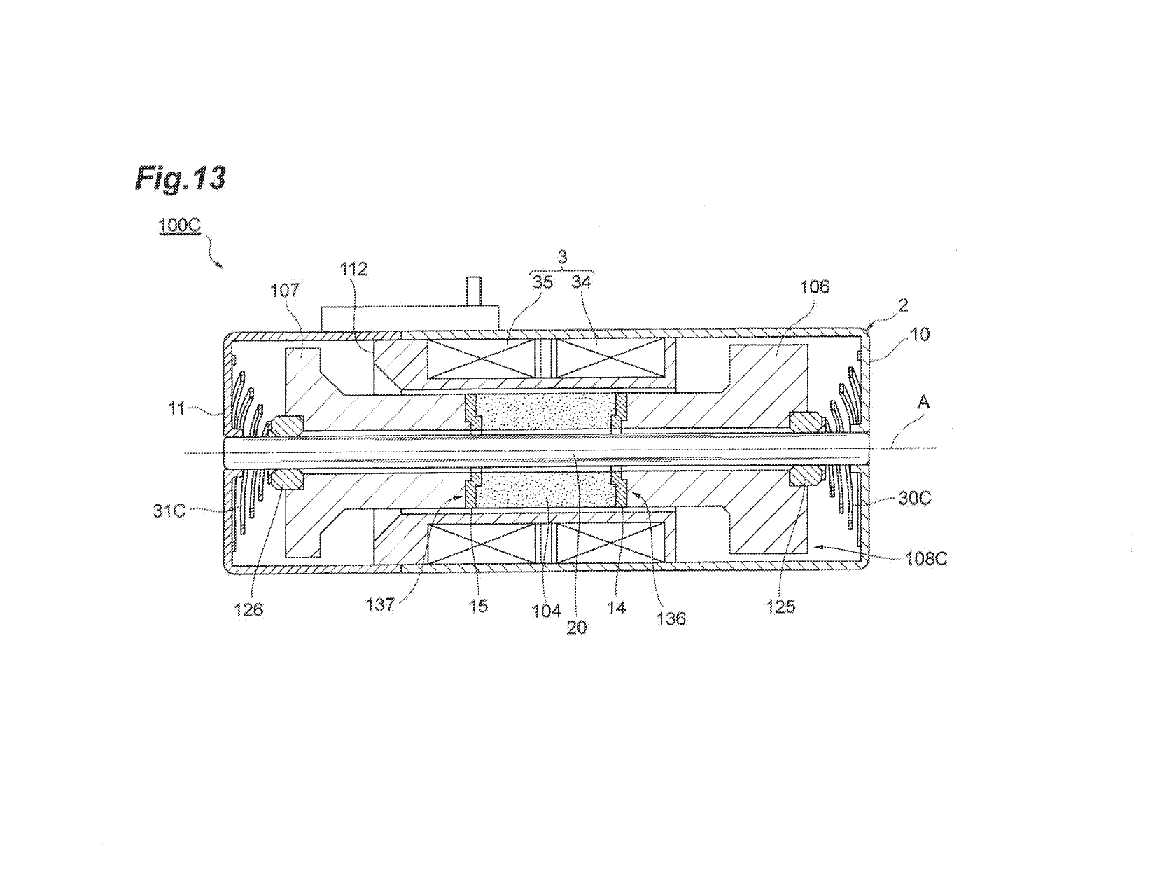

FIG. 13 is a longitudinal sectional view illustrating the seventh embodiment of the oscillating actuator. The oscillating actuator 100C illustrated in FIG. 13 differs from the oscillating actuator 100 in accordance with the fourth embodiment illustrated in FIG. 7 in that first and second leaf springs 30C, 31C in place of the first and second compression coil springs 30, 31 are used for supporting the first and second weights 106, 107. The bearings 125, 126 are utilized as spring bearings for the leaf springs 30C, 31C, respectively. Each of the first and second leaf springs 30C, 31C, which have the same form, is produced as a spring shaped like a circular truncated cone by punching a plurality of arc slits and a center opening in a disk. Conical coil springs can also be employed. This oscillating actuator 100C can also yield the above-mentioned rattling prevention effect for the magnet 104 and the like.

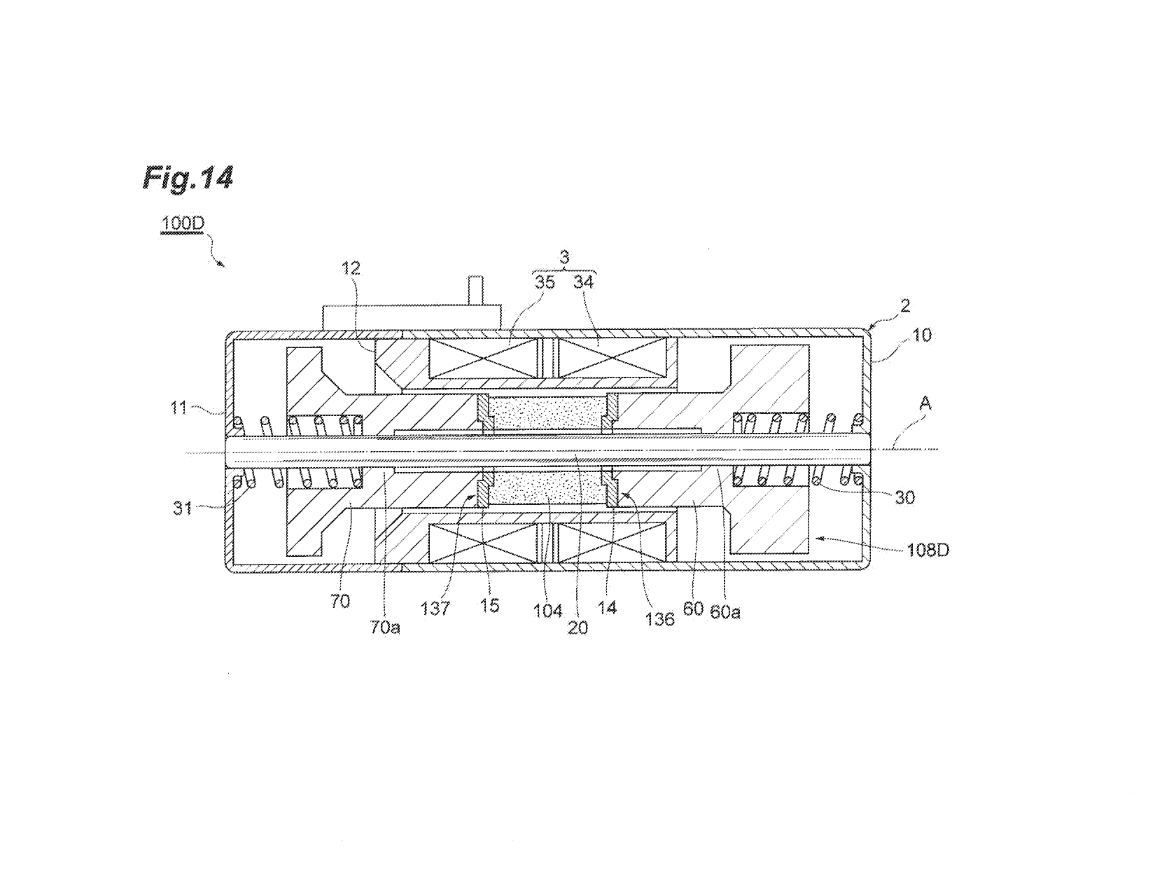

FIG. 14 is a longitudinal sectional view illustrating the eighth embodiment of the oscillating actuator. The oscillating actuator 100D illustrated in FIG. 14 differs from the oscillating actuator 100 in accordance with the fourth embodiment illustrated in FIG. 7 in that it is equipped with a movable element 108D having first and second weights 60, 70 formed with bearing parts 60a, 70a in place of the first and second weights 106, 107. While the bearings 125, 126 of the fourth to seventh embodiments are not provided, the first and second compression coil springs 30, 31 directly urge the first and second weights 60, 70. This oscillating actuator 100D can also yield the above-mentioned rattling prevention effect for the magnet 104 and the like.

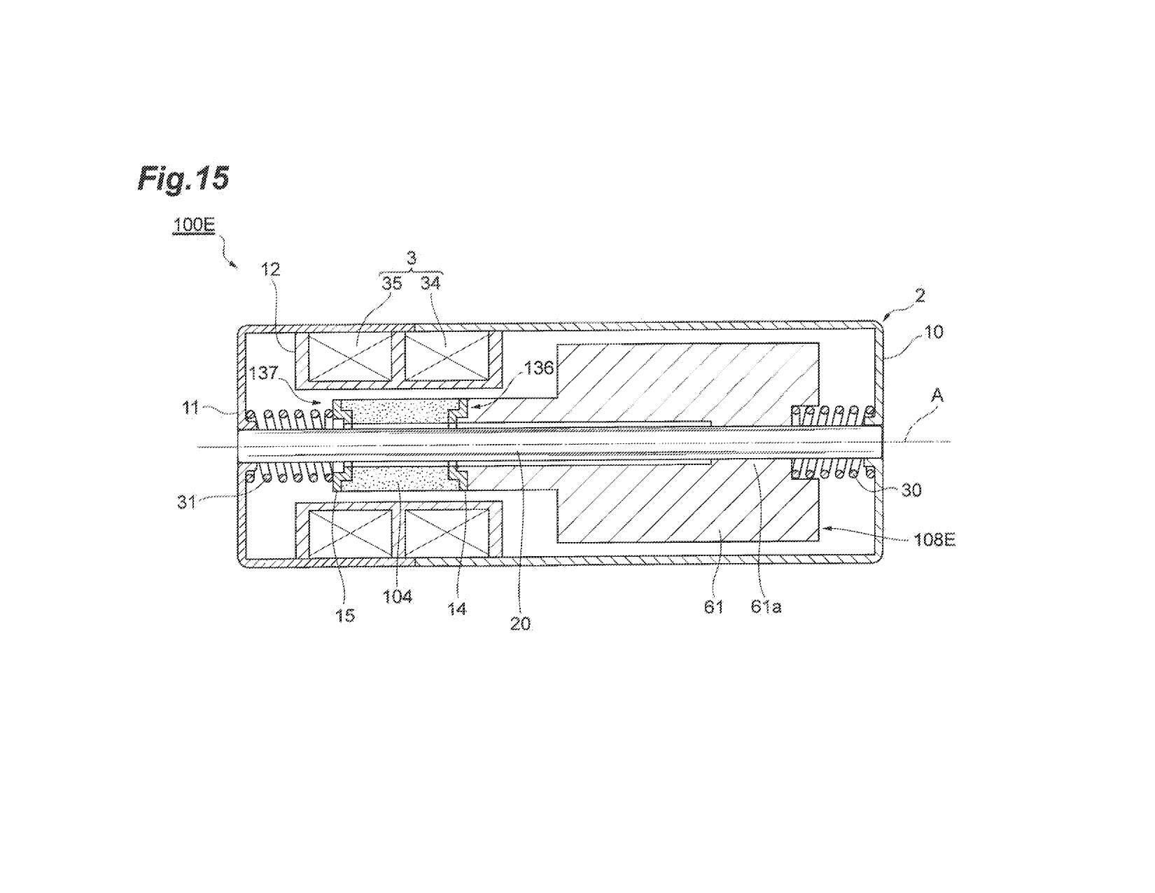

FIG. 15 is a longitudinal sectional view illustrating the ninth embodiment of the oscillating actuator. The oscillating actuator 100E illustrated in FIG. 15 differs from the oscillating actuator 100A in accordance with the fifth embodiment illustrated in FIG. 11 in that it is equipped with a movable element 108E having a first weight 61 formed with a bearing part 61a in place of the first weight 106A. While the bearing 125 is not provided, the first compression coil spring 30 directly urges the first weight 61. This oscillating actuator 100E can also yield the above-mentioned rattling prevention effect for the magnet 104 and the like.

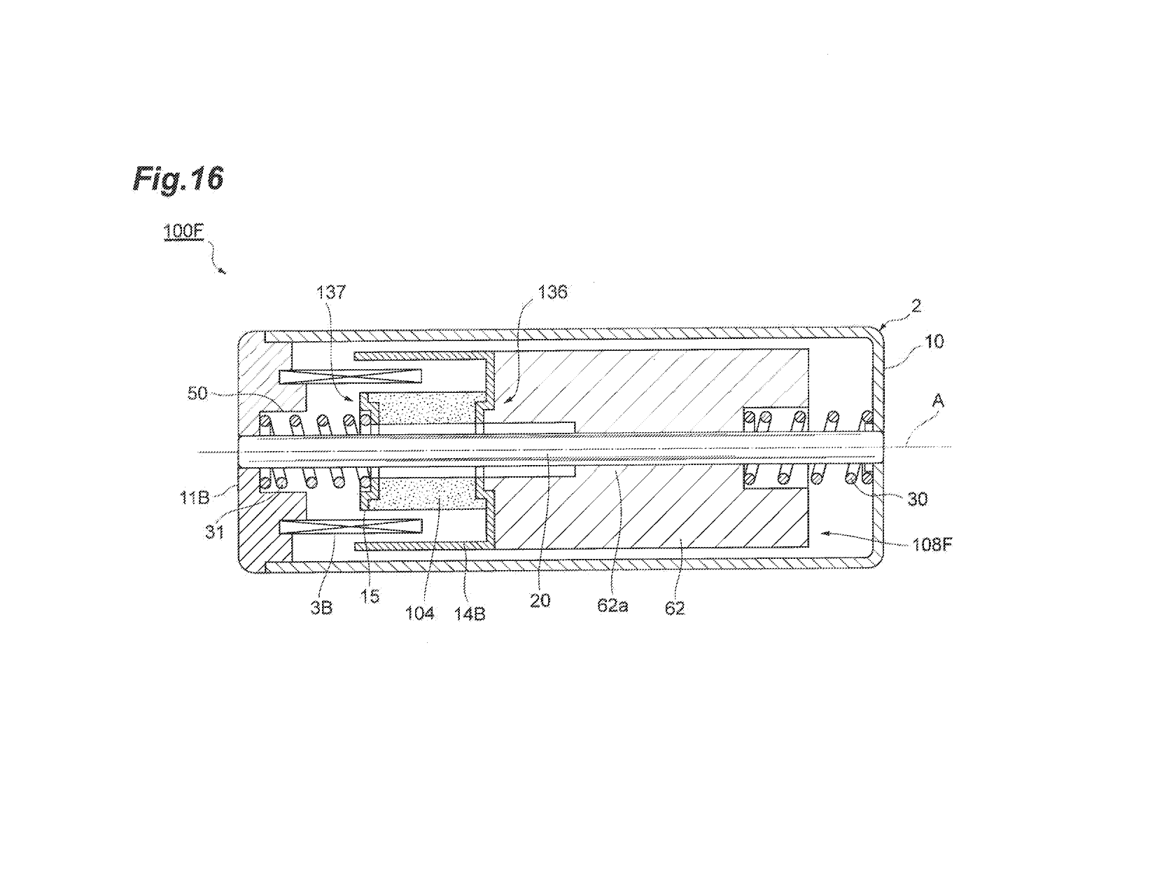

FIG. 16 is a longitudinal sectional view illustrating the tenth embodiment of the oscillating actuator. The oscillating actuator 100F illustrated in FIG. 16 differs from the oscillating actuator 100B in accordance with the sixth embodiment illustrated in FIG. 12 in that it is equipped with a movable element 108F having a first weight 62 formed with a bearing part 62a in place of the first weight 51. While the bearing 125 is not provided, the first compression coil spring 30 directly urges the first weight 62. This oscillating actuator 100F can also yield the above-mentioned rattling prevention effect for the magnet 104 and the like.

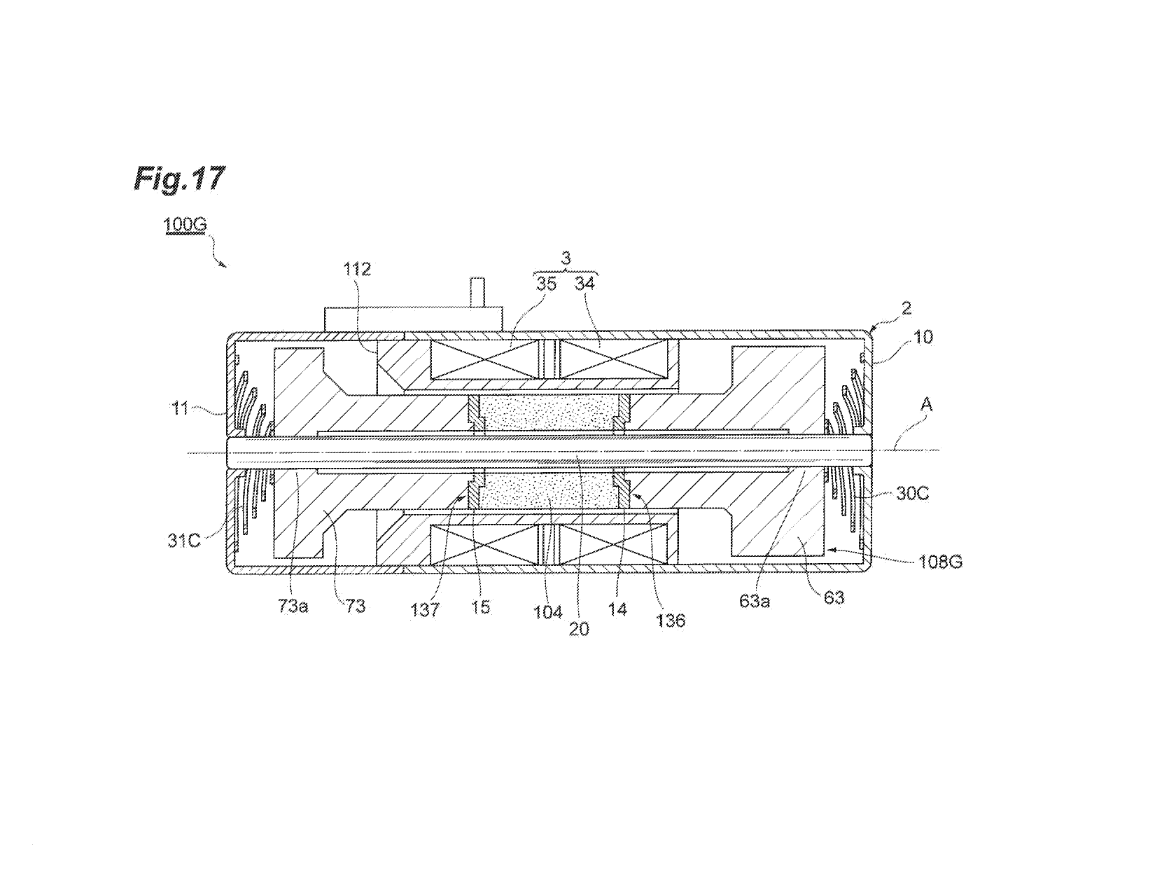

FIG. 17 is a longitudinal sectional view illustrating the eleventh embodiment of the oscillating actuator. The oscillating actuator 100G illustrated in FIG. 17 differs from the oscillating actuator 100C in accordance with the seventh embodiment illustrated in FIG. 13 in that it is equipped with a movable element 108G having first and second weights 63, 73 formed with bearing parts 63a, 73a in place of the first and second weights 106, 107. While the bearings 125, 126 are not provided, the first and second leaf springs 30C, 31C directly urge the first and second weights 63, 73, respectively. This oscillating actuator 100G can also yield the above-mentioned rattling prevention effect for the magnet 104 and the like.

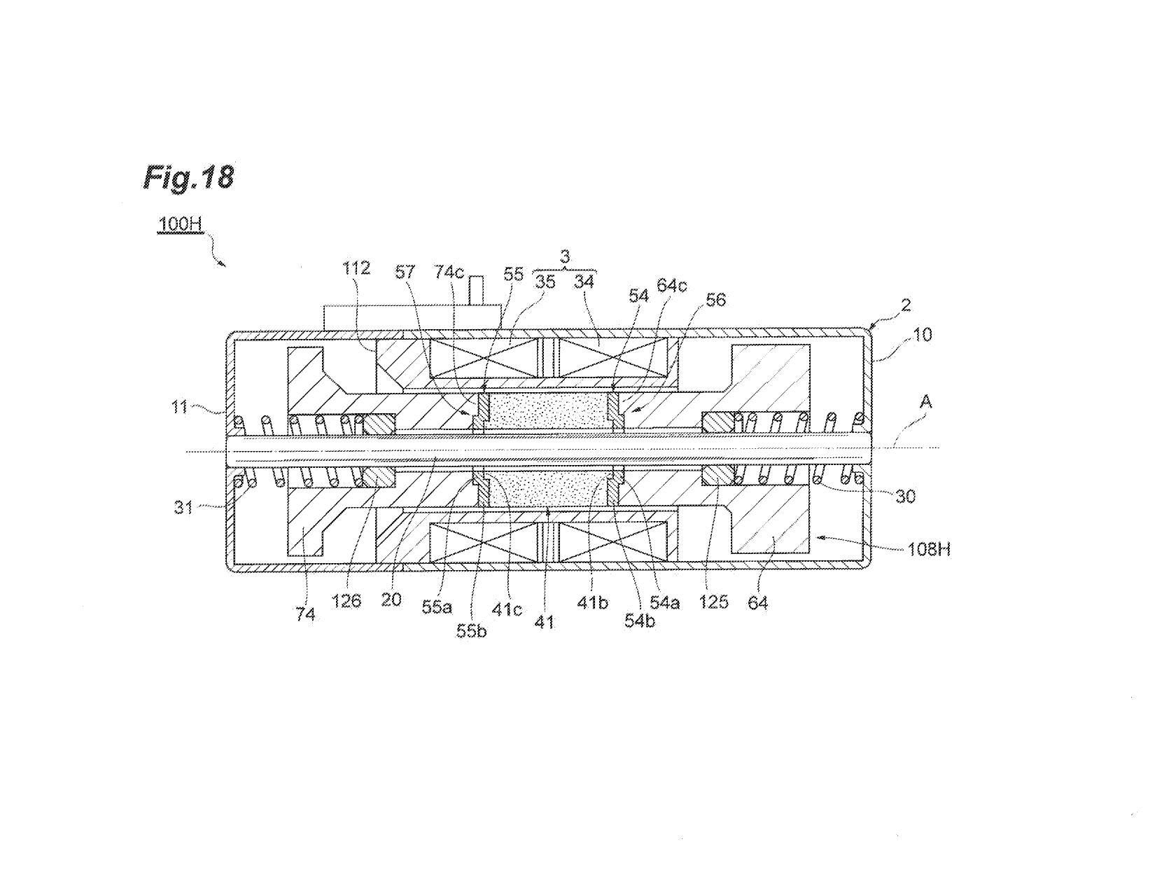

FIG. 18 is a longitudinal sectional view illustrating the twelfth embodiment of the oscillating actuator. The oscillating actuator 100H illustrated in FIG. 18 differs from the oscillating actuator 100 in accordance with the fourth embodiment illustrated in FIG. 8 in that it is equipped with a movable element 108H having pole yokes 54, 55 exhibiting depressions and projections in the reverse of those in the pole yokes 14, 15 in place of the movement regulators 136, 137. In the pole yokes 54, 55, second annular parts 54b, 55b are arranged away from first annular parts 54a, 55a toward the magnet 41. Along with this change, the magnet 41 is formed with columnar projections 41b, 41c, while first and second weights 64, 74 are formed with circular protrusions 64c, 74c. The movement regulators 136, 137 are changed to movement regulators 56, 57. This oscillating actuator 100H can also yield the above-mentioned rattling prevention effect for the magnet 41 and the like.

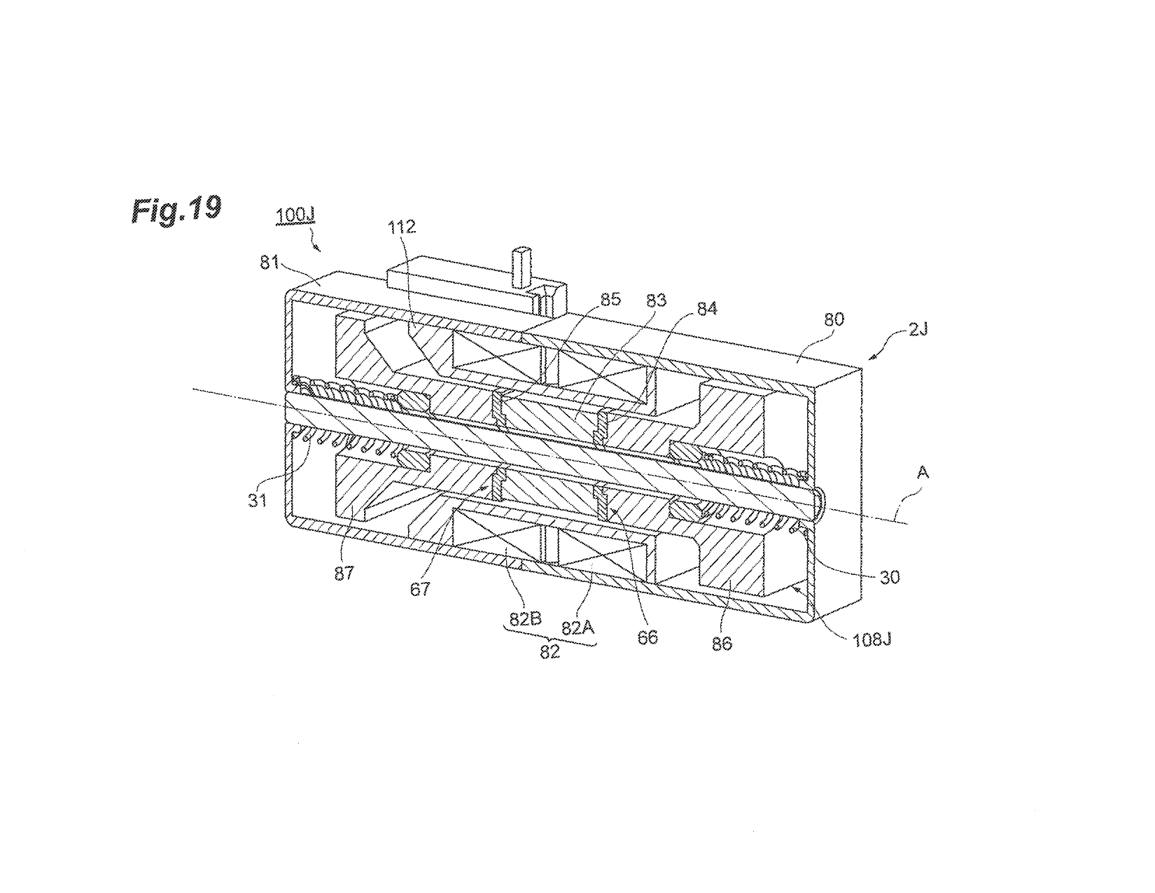

FIG. 19 is a perspective view illustrating the thirteenth embodiment of the oscillating actuator. The oscillating actuator 100J illustrated in FIG. 19 differs from the oscillating actuator 100 in accordance with the fourth embodiment illustrated in FIG. 8 in that it is equipped with a housing 2J comprising first and second housings 80, 81 each having a quadrangular cross section in place of the first and second housings 10, 11; a coil 82 comprising first and second coil parts 82A, 82B each having a quadrangular cross section in place of the first and second coils 34, 35; and a movable element 108J comprising a magnet 83, pole yokes 84, 85, and first and second weights 86, 87 each having a quadrangular cross section in place of the movable element 108. Along with this change, the movement regulators 136, 137 are changed to movement regulators 66, 67. The joint end faces C to F do not deviate circumferentially from each other as long as they are shaped like quadrangular rings. The cross-sections may also be polygonal. The joint end faces C to F may appropriately be selected from circular and polygonal, e.g., quadrangular, ring-shaped ones. This oscillating actuator 100J can also yield the above-mentioned rattling prevention effect for the magnet 83 and the like.

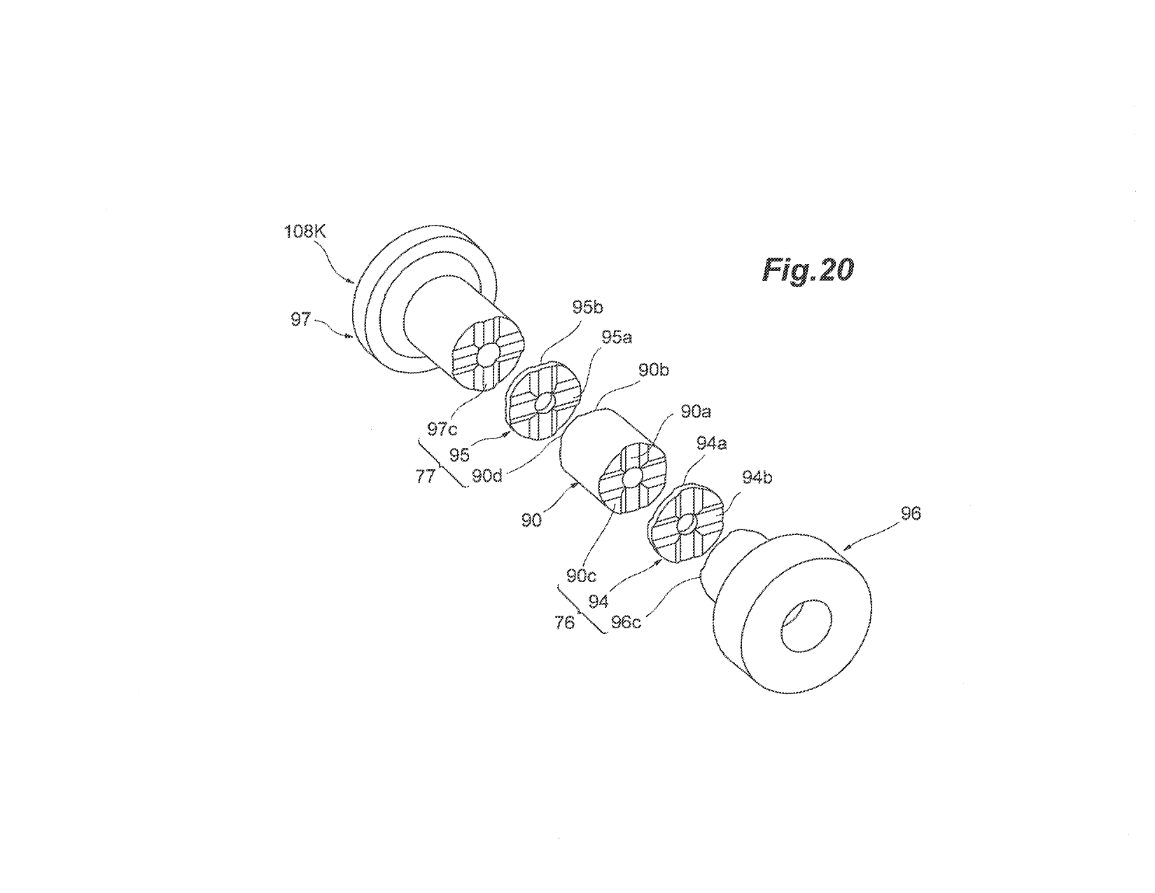

Though the fourth to thirteenth embodiments of the present invention are explained in detail in the foregoing, the present invention is not limited to the above-mentioned embodiments. While each of the above-mentioned embodiments relates to a case where a pole yoke has a stepped form at a boundary between annular parts having different diameters, this is not restrictive. The yoke and magnet and the yoke and weight may be in male-female engagement with each other at joint end faces having other forms. For example, as illustrated in FIG. 20, a movable element 108K may be constructed by forming cross-shaped projections 94a, 95a on surfaces (one surfaces) of the pole yokes 94, 95 facing the magnet 90 and cross-shaped grooves 94b, 95b on surfaces (the other surfaces) facing the first and second weights 96, 97 and bringing a magnet 90 and first and second weights 96, 97 into male-female engagement with the pole yokes 94, 95. In this case, cross-shaped grooves 90a, 90b adapted to join with the cross-shaped grooves 94a, 95a are formed on both sides of the magnet 90, respectively. The first and second weights 96, 97 are formed with cross-shaped projections 96c, 97c adapted to join with the cross-shaped grooves 94b, 95b, respectively. A part 90c of the magnet 90 excluding the cross-shaped groove 90a, the pole yoke 94, and the cross-shaped projection 96c of the first weight 96 form a movement regulator 76. A part 90d of the magnet 90 excluding the cross-shaped groove 90b, the pole yoke 95, and the cross-shaped projection 97c of the second weight 97 form a movement regulator 77.

While each of the above-mentioned embodiments relates to a case where the movement regulators restrain the magnet from moving by the male-female engagement between the weight and yoke and the male-female engagement between the yoke and magnet, this is not restrictive. For example, the frictional resistance between the weight and yoke and the frictional resistance between the yoke and magnet may be made greater, so that frictional engagement restrains the magnet from moving. In this case, the surface of the yoke may be processed such as to increase its coefficient of friction.

While each of the above-mentioned embodiments relates to a case where the weights, pole yokes, and magnet are joined together without using adhesives, this is not restrictive, and they may be joined together with adhesives.

When a magnetic circuit can be formed without using pole yokes, a movement regulator may be constructed by a male-female or frictional engagement between the weight and magnet. Simply changing the forms of respective joint end faces of the weight and magnet can also prevent the magnet from rattling in this case. Hence, a simple structure can prevent the magnet from rattling.

An elastic member such as a spring for urging the movable element 108 may be provided on not both sides but only one side of the movable element 108 and coupled to the end wall and movable element. The elastic member is not limited to the compression coil springs and leaf springs but may be tension coil springs coupled to the end walls and movable element. The housing may be split into two or more.

### INDUSTRIAL APPLICABILITY

One aspect of the present invention can improve the resistance to drop impact while securing stable oscillations. One aspect of the present invention can secure stable oscillations by preventing the magnet from rattling radially of the shaft.

### REFERENCE SIGNS LIST

1, 1A, 1B, 100, 100A to 100H, 100J . . . oscillating actuator; 2, 2J . . . housing; 3, 3B, 34, 35, 82, 82A, 82B . . . coil; 4, 41, 83, 90, 104 . . . magnet; 6, 7, 51, 60, 61, 62, 63, 64, 70, 73, 74, 86, 87, 96, 97, 106, 106A, 107 . . . weight; 8, 108, 108A to 108H, 108J, 108K . . . movable element; 10a, 11a . . . end wall; 20 . . . shaft; 14, 14B, 15, 21, 22, 54, 55, 84, 85, 94, 95 . . . pole yoke; 14a, 15a, 54a, 55a . . . first annular part; 14b, 15b, 54b, 55b . . . second annular part; 30, 31 . . . compression coil spring; 30C, 31C . . . leaf spring; 51a, 60a, 61a, 62a, 63a, 70a, 73a . . . bearing part; 56, 57, 66, 67, 76, 77, 136, 137 . . . movement regulator; 125, 126 . . . bearing (bearing part); A . . . axis of oscillation

1. An oscillating actuator having a coil arranged within a tubular housing and a magnet arranged within the housing while being surrounded by the coil, the coil and the magnet cooperating with each other so that the magnet oscillates linearly along an axis of oscillation of the housing, the oscillating actuator comprising:
a shaft, arranged along the axis of oscillation of the housing, having both ends fixed to end walls provided at both ends of the housing in the oscillation axis direction of the housing;
a movable element having the magnet adapted to pass the shaft therethrough and movable in an extending direction of the shaft and a weight arranged within the housing adjacent to the magnet in the extending direction of the shaft, adapted to pass the shaft therethrough, and movable integrally with the magnet; and
an elastic member, arranged between the movable element and the end wall, for urging the movable element in the oscillation axis direction;
wherein the coil comprises first and second coils wound annularly about the axis of oscillation and disposed in parallel with each other in the oscillation axis direction, the first and second coils having respective current flowing directions different from each other.

2. An oscillating actuator according to claim 1, wherein the weight comprises first and second weights arranged on both sides in the oscillation axis direction of the magnet;
wherein the elastic member comprises a first compression spring arranged between the first weight and one end wall of the housing and a second compression spring arranged between the second weight and the other end wall of the housing; and
wherein respective annular pole yokes are arranged between the magnet and the first and second weights.

3. An oscillating actuator having a coil arranged within a tubular housing and a magnet arranged within the housing while being surrounded by the coil, the coil and the magnet cooperating with each other so that the magnet oscillates linearly along an axis of oscillation of the housing, the oscillating actuator comprising:
a shaft, arranged along the axis of oscillation of the housing, having both ends fixed to end walls provided at both ends of the housing in the oscillation axis direction of the housing;
a movable element having the magnet adapted to pass the shaft therethrough and movable in an extending direction of the shaft and a weight arranged within the housing, adapted to pass the shaft therethrough, and movable integrally with the magnet; and
an elastic member, arranged between the movable element and the end wall, for urging the movable element in the oscillation axis direction;
wherein the weight has a bearing part slidable along the shaft; and
wherein the movable element is provided with a movement regulator for restraining the magnet from moving radially of the shaft with respect to the weight.

4. An oscillating actuator according to claim 3, wherein the movable element has a yoke adapted to pass the shaft therethrough and arranged between the magnet and the weight; and
wherein the movement regulator restrains the magnet from moving radially of the shaft by a male-female engagement between the weight and the yoke and a male-female engagement between the yoke and the magnet.

5. An oscillating actuator according to claim 4, wherein the yoke has a first annular part arranged about the shaft and a second annular part located on the outer periphery side of the first annular part and arranged away from the first annular part in the oscillation axis direction.

6. An oscillating actuator according to claim 3, wherein the movement regulator restrains the magnet from moving radially by a male-female engagement between the weight and the magnet.

7. An oscillating actuator according to claim 3, wherein a gap is formed between the magnet and the shaft.

8. An oscillating actuator according to claim 1, wherein the weight has a smaller diameter part at least partly surrounded by the coil, the smaller diameter part and the magnet having a length in the oscillation axis direction longer than that of the coil in the oscillation axis direction.

9. An oscillating actuator according to claim 3, wherein the weight has a smaller diameter part at least partly surrounded by the coil, the smaller diameter part and the magnet having a length in the oscillation axis direction longer than that of the coil in the oscillation axis direction.
